(19) United States
(12) Patent Application Publication
(10) Pub. No.: US 2024/0319134 A1
(43) Pub. Date: Sep. 26, 2024

(54) INTEGRATION OF LOW-VOLTAGE SENSING DEVICES INTO A HIGH-VOLTAGE ENVIRONMENT

(71) Applicant: PLENO, INC., San Diego, CA (US)

(72) Inventors: Michael STUBER, San Diego, CA (US); Jason TRACHEWSKY, San Diego, CA (US)

(21) Appl. No.: 18/732,116

(22) Filed: Jun. 3, 2024

Related U.S. Application Data
(63) Continuation of application No. PCT/US2022/051745, filed on Dec. 2, 2022.
(60) Provisional application No. 63/286,053, filed on Dec. 5, 2021.
(60) Provisional application No. 63/379,160, filed on Oct. 12, 2022.

(51) Int. Cl. G01N 27/414; B01L 3/00

(52) U.S. Cl. CPC G01N 27/4145; B01L 3/502715; G01N 27/4146; G01N 27/4148; B01L 2300/0636; B01L 2300/0645

(57) ABSTRACT

Methods for operating a low-voltage sensing device in a high-voltage digital microfluidics (DMF) system are provided that include: (a) a high-voltage DMF system, wherein the system comprises a DMF cartridge, (b) performing a droplet operation cycle, wherein the droplet operation cycle comprises applying a voltage to one or more of the plurality of droplet operation electrodes for droplet manipulation, and wherein the one or more electrodes are operated at a high-voltage during the droplet operation cycle; and (c) activating, during the droplet operation cycle, the protection mechanism of the low-voltage sensing device thereby isolating the low-voltage sensing device from the high-voltage applied to the one or more electrodes; and (d) deactivating the protection mechanism and performing a sensing cycle operation, wherein the sensing cycle operation occurs at a low-voltage.

### RELATED APPLICATIONS

This application is a continuation application of International Application No. PCT/US2022/051745, filed Dec. 2, 2022, which claims the benefit of U.S. Provisional Application No. 63/286,053, filed on Dec. 5, 2021, and U.S. Provisional Application No. 63/379,160, filed on Oct. 12, 2022, each of which is herein incorporated by reference in its entirety.

### FIELD OF THE INVENTION

The presently disclosed subject matter relates generally to the processing of biological materials and more particularly to a digital microfluidics (DMF) system, device, and methods of integrating low-voltage sensing devices in a high-voltage DMF environment.

### BACKGROUND

Microfluidic systems and devices are used in a variety of applications to manipulate, process and/or analyze biological materials. For example, microfluidic systems and devices are used for performing polymerase chain reaction (PCR) assays. In a real-time PCR assay, a positive reaction is detected by accumulation of a fluorescent signal. For example, in optical detection systems, fluorescent sensing may be used wherein excitation light may be directed toward, for example, a sample volume of interest. Then, the intensity of the emission light may be analyzed to determine the amount of target nucleic acid in the sample.

In microfluidic systems and devices, fluorescent sensing may be implemented using low-voltage transistor-based sensors, such as metal-oxide-semiconductor field-effect transistor (MOSFET) devices. Typically, the safe operating voltage range of these low-voltage sensing devices may be up to about 10 volts. However, in the DMF environment, high electrowetting voltages (e.g., 10s to 100s of volts) are present for performing droplet operations. Accordingly, there is risk of damage to any low-voltage devices, such as the low-voltage sensing devices, operating in the high-voltage DMF environment because of capacitive coupling to the high DMF voltages.

### SUMMARY

In one aspect, the disclosed subject matter is directed to a method for operating a low-voltage sensing device in a high-voltage digital microfluidics (DMF) system, the method comprising: (a) a high-voltage DMF system, wherein the system comprises a DMF cartridge, the cartridge comprising: (i) a bottom substrate, the bottom substrate having a plurality of droplet operation electrodes; (ii) a top substrate, wherein the top substrate is space apart from the bottom substrate forming a droplet operations gap therebetween; and (iii) a low-voltage sensing device, wherein the low-voltage sensing device further comprises a protection mechanism; (b) performing a droplet operation cycle, wherein the droplet operation cycle comprises applying a voltage to one or more of the plurality of droplet operation electrodes for droplet manipulation, and wherein the one or more electrodes are operated at a high-voltage during the droplet operation cycle; and (c) during the droplet operation cycle, activating the protection mechanism of the low-voltage sensing device thereby isolating the low-voltage sensing device from the high-voltage applied to the one or more electrodes; and (d) deactivating the protection mechanism and performing a sensing cycle operation, wherein the sensing cycle operation occurs at a low-voltage.

In some embodiments, the voltage applied to the one or more electrodes during the droplet operations cycle is turned off during the sensing cycle operation.

In some embodiments, the low-voltage sensing device is a low-voltage transistor-based sensor. In some embodiments, the low-voltage transistor-based sensor is selected from a metal-oxide-semiconductor field-effect transistor (MOSFET) sensor, an ion-sensing field-effect transistor (ISFET) sensor, a fin field-effect transistor (FinFET) sensor, or a photo-sensing device.

In some embodiments, the low-voltage sensing device is an extended gate field-effect transistor (FET), wherein the extended gate FET comprises a sensor and a gate, and wherein the extended gate FET further comprises a source, a drain, and a well, wherein each of the source, drain and well are capacitively coupled to the gate. In some embodiments, the extended gate FET further comprises a stacked metal layer comprising, a bottom metal layer, a middle metal layer and a top metal layer, wherein the bottom metal layer is electrically connected to each of the source, the drain and the well, and wherein the bottom metal layer, middle metal layer, and top metal layer are electrically connected to one another.

In some embodiments, the DMF cartridge comprises an insulator material between the droplet operations gap and the low-voltage sensing device. In some embodiments, the insulator material is sensitive to a pH change. In some embodiments, the insulator material is tantalum oxide (Ta₂O₅). In some embodiments, the insulator material is hafnium oxide (HfO₂). In some embodiments, the insulator material is hafnium-doped tantalum oxide.

In some embodiments, the bottom substrate further comprises one or more microwells. In some embodiments, the one or more microwells are hydrophilic.

In some embodiments, the protection mechanism comprises a means to isolate the voltage applied to the low-voltage sensing device during the droplet operation cycle. In some embodiments, the means to isolate the low-voltage sensing device is a cutoff transistor operable to isolate the voltage applied to the low-voltage sensing device during the DMF electrode operation cycle.

In some embodiments, the protection mechanism comprises one or more cutoff transistors, and wherein the one or more cutoff transistors are operable to isolate the source, the drain, and/or the well of extended gate field-effect transistor (FET). In some embodiments, the protection mechanism comprises one or more cutoff transistors, wherein said one or more cutoff transistors are coupled to a source, drain, and/or well, and wherein said one or more cutoff transistors are operable to isolate the low-voltage sensing device during the DMF electrode operation cycle.

In some embodiments, the protection mechanism comprises the application of an intermediate voltage to the low-voltage sensing device, and wherein the intermediate voltage comprises a voltage between ground and the high-voltage applied to the to the one or more electrodes during the droplet operation cycle.

In some embodiments, the protection mechanism comprises the application of an intermediate voltage to one or more of the source, the drain and/or the well of the low-voltage sensing device, and wherein the intermediate voltage comprises a voltage between ground and the high-voltage applied to the one or more electrodes during the droplet operation cycle.

In some embodiments, the low-voltage sensing device is operated at about 10 volts or less.

In some embodiments, the high-voltage applied to the one or more of the electrodes during the droplet operation cycle is about 10 volts or more.

In another aspect, the disclosed subject matter is directed to a digital microfluidics (DMF) cartridge, comprising: (a) a bottom substrate, the bottom substrate having a plurality of droplet operations electrodes; (b) a top substrate, wherein the top substrate is space apart from the bottom substrate forming a droplet operations gap therebetween; and (c) a low-voltage sensing device, wherein the low-voltage sensing device comprises a protection mechanism operable to isolate the low-voltage sensing device during a droplet operation cycle.

In some embodiments, the low-voltage sensing device is a low-voltage transistor-based sensor.

In some embodiments, the low-voltage transistor-based sensor is selected from a metal-oxide-semiconductor field-effect transistor (MOSFET) sensor, an ion-sensing field-effect transistor (ISFET) sensor, a fin field-effect transistor (FinFET) sensor, or a photo-sensing device.

In some embodiments, wherein the low-voltage sensing device is an extended gate field-effect transistor (FET), wherein the extended gate FET comprises a sensor and a gate, and wherein the extended gate FET further comprises a source, a drain, and a well, wherein each of the source, drain and well are capacitively coupled to the gate. In some embodiments, the extended gate FET further comprises a stacked metal layer comprising, a bottom metal layer, a middle metal layer and a top metal layer, wherein the bottom metal layer is electrically connected to each of the source, the drain and the well, and wherein the bottom metal layer, middle metal layer, and top metal layer are electrically connected to one another.

In some embodiments, the DMF cartridge comprises an insulator material between the droplet operations gap and the low-voltage sensing device. In some embodiments, the insulator material is sensitive to a pH change. In some embodiments, the insulator material is tantalum oxide (Ta₂O₅). In some embodiments, the insulator material is hafnium oxide (HfO₂). In some embodiments, the insulator material is hafnium-doped tantalum oxide.

In some embodiments, the bottom substrate further comprises one or more microwells. In some embodiments, the one or more microwells are hydrophilic.

In some embodiments, the protection mechanism comprises a means to isolate the voltage applied to the low-voltage sensing device during the droplet operation cycle. In some embodiments, the means to isolate the low-voltage sensing device is a cutoff transistor operable to isolate the voltage applied to the low-voltage sensing device during the DMF electrode operation cycle.

In some embodiments, the protection mechanism comprises one or more cutoff transistors, and wherein the one or more cutoff transistors are operable to isolate the source, the drain, and/or the well of extended gate field-effect transistor (FET).

In some embodiments, the protection mechanism comprises one or more cutoff transistors, wherein said one or more cutoff transistors are coupled to a source, drain, and/or well, and wherein said one or more cutoff transistors are operable to isolate the low-voltage sensing device during the DMF electrode operation cycle.

In some embodiments, the DMF cartridge further comprises a flip-chip cartridge.

In some embodiments, the flip-chip cartridge is mounted atop the bottom substrate and alongside of the top substrate.

In some embodiments, the top substrate further comprises one or more loading ports operable for loading a liquid to be processed on DMF flip-chip cartridge.

In still another aspect, the disclosed subject matter is directed to a method for operating a low-voltage sensing device in a high-voltage digital microfluidics (DMF) system, the method comprising: (a) a high-voltage DMF system, wherein the system comprises a DMF cartridge, the cartridge comprising: (i) a bottom substrate, the bottom substrate having a plurality of droplet operations electrodes; (ii) a top substrate, wherein the top substrate is space apart from the bottom substrate forming a droplet operations gap therebetween; and (iii) a low-voltage sensing device, wherein the low-voltage sensing device further comprises a protection mechanism; (b) performing a droplet operation cycle, wherein the droplet operation cycle comprises applying a voltage to one or more of the plurality of electrodes for droplet manipulation, and wherein the one or more electrodes are operated at a high-voltage during the droplet operation cycle; and (c) during the droplet operation cycle, activating the protection mechanism of the low-voltage sensing device thereby isolating the low-voltage sensing device from the high-voltage applied to the one or more electrodes, wherein the protection mechanism comprises the application of an intermediate voltage to the low-voltage sensing device, and wherein the intermediate voltage comprises a voltage between ground and the high-voltage applied to the to the one or more electrodes during the droplet operation cycle; and (d) deactivating the protection mechanism and performing a sensing cycle operation, wherein the sensing cycle operation occurs at a low-voltage.

In some embodiments, the voltage applied to the one or more electrodes during the droplet operations cycle is turned off during the sensing cycle operation.

In some embodiments, the low-voltage sensing device is a low-voltage transistor-based sensor.

In some embodiments, the low-voltage transistor-based sensor is selected from a metal-oxide-semiconductor field-effect transistor (MOSFET) sensor, an ion-sensing field-effect transistor (ISFET) sensor, a fin field-effect transistor (FinFET) sensor, or a photo-sensing device.

In some embodiments, the low-voltage sensing device is an extended gate field-effect transistor (FET), wherein the extended gate FET comprises a sensor and a gate, and wherein the extended gate FET further comprises a source, a drain, and a well, wherein each of the source, drain and well are capacitively coupled to the gate.

In some embodiments, the extended gate FET further comprises a stacked metal layer comprising, a bottom metal layer, a middle metal layer and a top metal layer, wherein the bottom metal layer is electrically connected to each of the source, the drain and the well, and wherein the bottom metal layer, middle metal layer, and top metal layer are electrically connected to one another.

In some embodiments, the DMF cartridge comprises an insulator material between the droplet operations gap and the low-voltage sensing device. In some embodiments, the insulator material is sensitive to a pH change. In some embodiments, the insulator material is tantalum oxide (Ta₂O₅). In some embodiments, the insulator material is hafnium oxide (HfO₂). In some embodiments, the insulator material is hafnium-doped tantalum oxide.

In some embodiments, the bottom substrate further comprises one or more microwells. In some embodiments, wherein the one or more microwells are hydrophilic.

In some embodiments, the protection mechanism further comprises one or more cutoff transistors, and wherein the one or more cutoff transistors are operable to isolate the source, the drain, and/or the well of extended gate field-effect transistor (FET).

In some embodiments, the low-voltage sensing device is operated at about 10 volts or less.

In some embodiments, the high-voltage applied to the one or more electrodes during the droplet operation cycle is about 10 volts or more

In some embodiments, the intermediate voltage is between ground and the high-voltage applied during the droplet operation cycle.

In some embodiments, the intermediate voltage is calculated to be a safe voltage based on the high-voltage applied during the droplet operation cycle and based on a breakdown voltage of the sensor oxide.

### BRIEF DESCRIPTION OF THE DRAWINGS

The features and advantages of the present invention will be more clearly understood from the following description taken in conjunction with the accompanying drawings, which are not necessarily drawn to scale, and wherein:

FIG. 1 illustrates a block diagram of an example of the presently disclosed microfluidics system including low-voltage sensing devices integrated safely into a high-voltage DMF environment;

FIG. 2 illustrates a block diagram of an example of a droplet operations device of the presently disclosed microfluidics system and wherein the droplet operations device may include low-voltage sensing devices integrated safely into a high-voltage DMF environment;

FIG. 3A and FIG. 3B illustrate a plan view and a cross-sectional view, respectively, of an example of a DMF structure on which the droplet operations device may be based;

FIG. 4 illustrates a side view of another configuration of the DMF structure shown in FIG. 3B;

FIG. 5A and FIG. 5B illustrate schematic diagrams of examples of equivalent circuits showing the capacitive coupling with respect to the droplet in, for example, the DMF structure shown in FIG. 4;

FIG. 6A and FIG. 6B illustrate side views of examples of DMF structures including a low-voltage sensing device alone without protection mechanisms;

FIG. 7 illustrates a schematic diagram of an example of an equivalent circuit showing the capacitive coupling with respect to the low-voltage sensing device of the DMF structure shown in FIG. 6;

FIG. 8 illustrates a schematic diagram of an example of a low-voltage sensing device including an example of protection mechanisms for ensuring the safe operation of the low-voltage sensing device in the high-voltage environment of DMF;

FIG. 9 shows pictorially the low-voltage sensing device along with the protection mechanisms shown in FIG. 8;

FIG. 10 illustrates an example of a timing diagram of the operation of a low-voltage sensing device including protection mechanisms for ensuring the safe operation of the low-voltage sensing device in the high-voltage environment of DMF;

FIG. 11 illustrates a flow diagram of an example of a method of using the presently disclosed microfluidics system including low-voltage sensing devices integrated into a high-voltage DMF environment;

FIG. 12, FIG. 13, FIG. 14, and FIG. 15 illustrate plan views of examples of electrode arrangements including a nanowell array (not to scale) and wherein each nanowell of the nanowell array may include a low-voltage sensing device with protection mechanisms

FIG. 16 illustrates a block diagram of an example of the presently disclosed microfluidics system including low-voltage sensing devices integrated safely into a high-voltage DMF environment and implemented on a DMF flip-chip cartridge that may further include flip-chip technology;

FIG. 17 illustrates a side view of a portion of an example of a DMF flip-chip cartridge;

FIG. 18A and FIG. 18B illustrate a plan view and a cross-sectional view, respectively, showing more details of another example of a DMF flip-chip cartridge and wherein the DMF flip-chip cartridge includes one top substrate;

FIG. 19 illustrates a side view of a Detail A of FIG. 6A and FIG. 6B and showing more details of the transition portion of the DMF flip-chip cartridge from the bulk DMF to the DMF operations of the DMF flip-chip; and

FIG. 20A and FIG. 20B illustrate a plan view and a cross-sectional view, respectively, showing more details of yet another example of a DMF flip-chip cartridge and wherein the DMF flip-chip cartridge includes two top substrates.

### DEFINITIONS

“Activate,” with reference to one or more electrodes, means affecting a change in the electrical state of the one or more electrodes which, in the presence of a droplet, results in a droplet operation. Activation of an electrode can be accomplished using alternating current (AC) or direct current (DC). Any suitable voltage may be used. For example, an electrode may be activated using a voltage which is greater than about 5 V, or greater than about 20 V, or greater than about 40 V, or greater than about 100 V, or greater than about 200 V or greater than about 300 V. The suitable voltage being a function of the dielectric's properties such as thickness and dielectric constant, liquid properties such as viscosity and many other factors as well. Where an AC signal is used, any suitable frequency may be employed. For example, an electrode may be activated using an AC signal having a frequency from about 1 Hz to about 10 MHz, or from about 1 Hz and 10 KHz, or from about 10 Hz to about 240 Hz, or about 60 Hz

“Amplify” or “amplification” means copying a strand of DNA to produce a complementary strand. Amplification may, for example, be accomplished by using a polymerase to copy a target strand

“Analyte” means a substance or chemical constituent that is being detected, identified, and measured. An analyte may be, for example, a biological analyte (or bioanalyte), such as nucleic acid (DNA or RNA, etc.) and protein.

“Biomarker” means a measurable substance in a sample whose presence is indicative of some phenomenon such as disease, infection, or environmental exposure. A biomarker may be, for example, a nucleic acid, a protein, or a small molecule.

“Bisulfite conversion” refers to a process in which genomic DNA is denatured (made single-stranded) and treated with sodium bisulfite, leading to deamination of unmethylated cytosines into uracils, while methylated cytosines (i.e., 5-methylcytosine and 5-hydroxymethylcytosine) remain unchanged.

“Capture antibody” refers to an antibody or fragment thereof that is used to probe a sample for the presence of a specific protein or small molecule biomarker in a sample. In some cases, a capture antibody may be immobilized on a solid support, such as a magnetically responsive bead.

“Cell-free nucleic acid” (cfNA) or “circulating cell-free nucleic acid” (ccfNA) refers to a mixture of single- or double-stranded nucleic acids released into a body fluid. cfNAs include DNA, RNA, microRNA (miRNA), long non-coding RNA (lncRNA), fetal DNA/RNA, and mitochondrial DNA/RNA. cfNAs can be derived from both normal (healthy) or diseased cells. In some cases, cell-free DNA (cfDNA) can be associated with different epigenetic modifications (e.g., DNA methylation), which can show disease-related variations.

“Detector” means a device or method that can be used to verify the presence of a substance or a chemical or physical reaction. A detector can be one of many electrical detectors, for example, a pH sensor (e.g., an ISFET), an impedance sensor, a capacitive sensor, or a mechanical sensor (e.g., a MEMs frequency-based cantilever). A detector can also be one of many optical detectors, for example, a photoresistor, photodiode, avalanche photodiode, single-photon avalanche detector, or photomultiplier tube). A detector could also comprise a radiation detector, chemical sensor, or other methods of detection such as can be used to verify chemical reactions or the presence of certain substances.

“Digital PCR” (dPCR) refers to a nucleic acid detection technology that is based on the amplification of single target DNA molecules in many separate reactions.

“DNA methylation” refers to the attachment of methyl groups to cytosine nucleotides at CpG sites in the genome.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads or other types of solid particles.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., patterned on, layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, or within the gap itself. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, NJ) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define on-actuator dispensing reservoirs. The spacer height may, for example, be from about 5 μm to about 1000 μm, or about 100 μm to about 400 μm, or about 200 μm to about 350 μm, or about 250 μm to about 300 μm, or about 275 μm. The spacer may, for example, be formed of features or layers projecting from the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be affected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrowetting mediated, or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g., external syringe pumps, pneumatic membrane pumps, vibrating membrane pumps, vacuum devices, centrifugal forces, piezoelectric/ultrasonic pumps and acoustic forces); electrical or magnetic principles (e.g., electroosmotic flow, electrokinetic pumps, ferrofluidic plugs, electrohydrodynamic pumps, attraction or repulsion using magnetic forces and magnetohydrodynamic pumps); thermodynamic principles (e.g., gas bubble generation/phase-change-induced volume expansion); other kinds of surface-wetting principles (e.g., electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a circular disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, DE), members of the Cytop® family of materials (available from Asahi Glass Company, Tokyo, Japan), coatings in the FLUOROPEL® family of materials (available from Cytonix Corporation, Beltsville, MD), silane coatings, fluorosilane coatings, hydrophobic phosphonate derivatives (e.g., those sold by Aculon, Inc), and NOVEC™ electronic coatings (available from 3M Company, St. Paul, MN), other fluorinated monomers suitable for plasma-enhanced chemical vapor deposition (PECVD), and organosiloxanes (e.g., SiOC) suitable for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS) or poly(3,4-ethylenedioxythiophene) poly(ethylene glycol) (PEDOT:PEG). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, quartz, silicon, and/or other semiconductor materials as the substrate.

In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose CA); ARLON™ 1IN (available from Arlon, Inc, Santa Ana, CA).; NELCO® N4000-6 and N5000-30/32 (available from Park Electrochemical Corp., Melville, NY); ISOLA™ FR406 (available from Isola Group, Chandler, AZ), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, DE); NOMEX® brand fiber (available from DuPont, Wilmington, DE); and paper.

Various materials are also suitable for use as the dielectric component of the droplet actuator. Examples include: vapor deposited polymer dielectrics, such as parylene C, parylene N, parylene D, parylene F and proprietary formulations such as PARYLENE HT® (available from Kisco, Indianapolis, IN); spin-coated, spray-coated, or dip-coated amorphous fluoropolymers such as the CYTOP®, TEFLON® AF, and FLUOROPEL® families of coatings; soldermask materials such as liquid photoimageable soldermasks like TAIYO™ PSR4000 series, TAIYO™ PSR and AUS series (available from Taiyo America, Inc., Carson City, NV), and PROBIMER™ 8165 (available from Huntsman Advanced Materials Americas Inc., Los Angeles, CA) both of which may be especially suitable for applications where thermal control is important; dry film soldermask, such as those in the VACREL® dry film soldermask line (available from DuPont, Wilmington, DE); other polymer films, such as polyimide film (e.g., KAPTON® polyimide film, available from DuPont, Wilmington, DE), polyethylene films, fluoropolymer films (e.g., FEP, PTFE); polyester films; polyethylene naphthalate films; cyclo-olefin copolymer (COC) films; cyclo-olefin polymer (COP) films; and polypropylene films. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan or black flexible circuit materials, such as DuPont™ Pyralux® HXC and DuPont™ Kapton® MBC (available from DuPont, Wilmington, DE).

In some cases, the top and/or bottom substrate includes a glass or silicon substrate on which features have been patterned using process technology borrowed from semiconductor device fabrication including the deposition and etching of thin layers of materials using microlithography. The top and/or bottom substrate may consist of a semiconductor backplane (i.e., a thin-film transistor (TFT) active-matrix controller) on which droplet operations electrodes have been formed. Transistors formed on the same substrate as the droplet operations electrodes may be used for addressing, switching and storing the current state of each electrode within an array of electrodes. Microelectronic circuits may also be provided on the same substrate for controlling the droplet operations electrodes and for making certain measurements or capturing data from certain sensors. For example, row decoders and column decoders may be used to select a particular electrode within an array for the purpose of activating or de-activating an electrode. Memory may be provided on the substrate for storing the state of each electrode, storing programs or storing of results such as sensor outputs. Memory may be a volatile format, such as SRAM or DRAM, or a non-volatile format, such as EPROM. Additional circuits may be provided such as amplifiers, drivers, multiplexers, demultiplexers, serial data interfaces and the like. In general, the microelectronic circuits are formed directly on an semiconductor substrate such as crystalline silicon or TFT-glass and the droplet operations electrodes are formed on top of the microelectronics layer where normally a passivation layer may be provided. Typically, the droplet operation electrodes are connected to one or more conducting layers (i.e., wires) formed in a lower layer and covered on top by a dielectric layer. The droplet operations electrode may be formed using any conductive material including those typically used for wiring layers in typical CMOS or TFT fabrication such as Al or Cu. The dielectric layer may be any suitable insulator typically used in CMOS or TFT fabrication such as SiO₂ or Si₃N₄. The dielectric layer may also be a less traditional material selected specifically for its dielectric properties such as Al₂O₃, TiN, SiOC, or BST.

Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; vibrating a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include loading assisted by the use of pressure (i.e., positive displacement or dynamic effects such as centrifugation and gravity) and loading assisted by capillary effects (i.e., wettability gradients). Various instruments may be employed for “loading” including precision pipettes, transfer pipettes, robotic pipettors, liquid dispensers, and all manner of pumps, valves, tubing and channels. In some cases, electrode-mediated droplet operations are further facilitated by the use of hydrophilic and/or hydrophobic regions on surfaces and/or by physical obstacles. For example, capillaries can be formed by patterning hydrophilic features within a hydrophobic field on a substrate. Such capillaries can be used to convey liquid between locations where it may difficult to place or operate droplet operations electrodes. For example, between two different substrates containing droplet operations electrodes such as a PCB-based module and a CMOS-based module or between two CMOS-based modules or between a droplet operations module and a different type of module such as a reagent storage and preparation module. For examples of droplet operations, see the patents and patent applications cited above under the definition of “droplet actuator.”

Impedance sensing or optical sensing techniques may sometimes be used to monitor or confirm the outcome of a droplet operation. Examples of electrical impedance sensing techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing techniques may be used to confirm the presence, amount or absence of a droplet at a specific electrode position. For example, the presence of a dispensed droplet at the destination electrode following a droplet dispensing operation confirms that the droplet dispensing operation was effective. Similarly, the presence of a droplet at a detection spot or other appropriate checkpoint in an assay protocol may confirm that a previous set of droplet operations was successfully performed. Droplet transport speeds can be quite fast. For example, in various embodiments, transport (i.e., transfer) of a droplet from one electrode to the next may be completed within about 1 sec, or about 0.1 sec, or about 0.01 sec, or about 0.001 sec. In one embodiment, the electrode is operated in AC mode but is switched to DC mode while imaging in order to reduce electrical and mechanical noise.

It is helpful for conducting droplet operations for the total footprint area of the droplet to be similar to or larger than the total footprint area of the activated electrodes performing a droplet operation. In other words, if the unit electrode is of size (i.e., area) x then it will be most effective for performing operations on a droplet also of size x. A single unit electrode can also perform droplet operations on droplets of size 2×, 3× or larger but the operations may become less consistent owing to the fact that only a portion of the droplet footprint is under control. In order to address this limitation multiple adjacent electrodes may be activated together in groups (i.e., effectively simulating the effect of single a larger electrode). For example, a 3× droplet may be usefully controlled using 2 or 3 electrodes together, a 4× droplet may be usefully controlled using 3 or 4 electrodes together and so on. A wide range of different droplet volumes may therefore be manipulated on a single droplet actuator using these techniques. For example, a 1× droplet, a 5× droplet, a 10× droplet, a 20× droplet, a 50× droplet and a 100× droplet may all be operated on using the same device with different patterns of electrode activation.

“Electrophoresis” means a process used to separate DNA, RNA, or protein molecules based on their size and electrical charge. An electric current is used to move molecules to be separated through a gel. Pores in the gel work like a sieve, allowing smaller molecules to move faster than larger molecules. The conditions used during electrophoresis can be adjusted to separate molecules in a desired size range.

“Electroporation” means the significant increase in the electrical conductivity and permeability of the cell plasma membrane caused by an externally applied electrical field.

“Elution” means the process of extracting one material from another by washing with a solvent. For example, a process by which an analyte of interest (e.g., DNA, RNA, protein) may be separated out with the help of a buffer or a mixture of buffers and some other chemicals.

“Enzyme-linked immunosorbent assay” (ELISA) or “enzyme immunoassay” (EIA) refers to a technique for detecting and quantifying soluble substances such as peptides, proteins, and antibodies.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane. The filler fluid may be or include a halogenated oil, such as a fluorinated or perfluorinated oil. The filler fluid may fill the entire gap of the droplet actuator or may only coat one or more surfaces of the droplet actuator. Filler fluids may be selected to improve droplet operations and/or reduce loss of reagent or target substances from droplets, reduce formation of unwanted microdroplets, reduce cross contamination between droplets, reduce contamination of droplet actuator surfaces, reduce degradation of droplet actuator materials, reduce evaporation of droplets, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77 g/mm³), Galden HT200 (bp=200° C., viscosity=2.4 cSt, density=1.79 g/mm³), Galden HT230 (bp=230° C., viscosity=4.4 cSt, density=1.82 g/mm³) (all from Solvay Solexis); those in the Novec line, such as Novec 7500 (bp=128° C., viscosity=0.8 cSt, density=1.61 g/mm³), Fluorinert FC-40 (bp=155° C., viscosity=1.8 cSt, density=1.85 g/mm³), Fluorinert FC-43 (bp=174° C., viscosity=2.5 cSt, density=1.86 g/mm³) (both from 3M). In general, selection of perfluorinated filler fluids is based on kinematic viscosity (<7 cSt is preferred, but not required), and on boiling point (>150° C. is preferred, but not required, for use in elevated temperature operations such as PCR. Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents or samples used in the specific assay protocols and effective interaction or non-interaction with droplet actuator materials. For example, fluorinated oils may in some cases be doped with fluorinated surfactants, e.g., Zonyl FSO-100 (Sigma-Aldrich) and/or others. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Pub. No. 20080283414, entitled “Electrowetting Devices,” filed on May 17, 2007; the entire disclosures of which are incorporated herein by reference, as well as the other patents and patent applications cited herein.

“Forward primer” means a short nucleic acid sequence that hybridizes with the 3′ end of the noncoding or the template strand of a gene and serves as the starting point to synthesize the coding sequence.

“Hybridization” means a process of combining two complementary single-stranded deoxyribonucleic acid (DNA) or ribonucleic acid (RNA) molecules and allowing them to form a single double-stranded molecule through base pairing.

“Liquid biopsy” refers a technical way to analyze nonsolid biological tissue by detection of cells and free nucleic acids that enter body fluids. to a diagnostic platform utilizing the detection of biomarkers in various body fluids. In some cases, liquid biopsy may refer to the real-time monitoring of the dynamic alterations of disease by detecting circulating tumor cells, circulating cell-free DNA (cfDNA), exosomes, and so on.

“Primer” means a sequence of DNA or RNA which serves as a starting point for nucleic acid synthesis. A primer may also be referred to as an “oligonucleotide”. In some cases, a single primer may be used in a DNA synthesis reaction. In some cases, a pair of primers may be used in a DNA synthesis reaction. Primers can either be specific to a particular DNA nucleotide sequence or they can be “universal” or complementary to nucleotide sequences that are common in a particular set of DNA molecules.

“Probe”, with regard to nucleic acids, means a single-stranded sequence of DNA or RNA used to detect and/or isolate a target nucleic acid sequence in a sample by molecular hybridization. Probes are also referred to as “molecular markers” or “markers.” The length of a probe can vary (e.g., 100 to 1000 bases). A probe may be labeled with a tag. For example, in some cases, a probe may be labeled with a tag, such as a fluorophore, for detection of a target nucleic acid sequence in a sample. In some cases, a probe may be labeled with a tag, such as biotin, for isolation of a target nucleic acid sequence in a sample for subsequent processing and analysis. In some cases, a probe may include a sequence tag. For example, a probe may include a universal nucleic acid sequence tag to support a universal PCR amplification reaction. In some cases, a probe may include a unique nucleic acid sequence tag that can be used to differentiate individual probes in, for example, a multiplexed reaction.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Reverse primer” means a short nucleic acid sequence that hybridizes with the 3′ end of the coding or the non-template strand and serves as the starting point to synthesize the noncoding sequence.

“Single nucleotide polymorphisms” (SNPs) refers to single nucleotide (A, G, C, or T) changes in DNA.

“Substrate” means a structure that physically supports other components of a droplet actuator. A substrate may comprise an active device, multiple layers of conductors for wiring and/or DMF pads, pads for temporary or permanent electrical connection to the substrate for power, ground or signals, or windows for optical detection through the substrate. Substrates may be formed of PC board material, such as FR4, or it may be a laminate comprising such materials as polyimide or BT (bismaleimide triazine). Substrates can also be formed of ceramic with one or more conductor levels such as Low-Temperature Co-fired Ceramic (LTCC). Substrates can also be manufactured using so-called “wafer-level fanout” packaging techniques, such as described at https://amkor.com/technology/swift/ or https://ase.aseglobal.com/en/technology/fan_out.

“Target enrichment” or “enrichment” refers to selectively isolating (“capturing”) a biomarker or group of biomarkers in a sample for analysis. With regard to nucleic acid targets, target enrichment works by isolating (capturing) nucleic acid sequences of interest by hybridization to target-specific probes. For example, in some cases target enrichment works by capturing nucleic acid sequences of interest by hybridization to target-specific biotinylated probes, which are then isolated, for example, by a magnetic bead-based pulldown process.

“Target nucleic acid molecule,” or “gene target,” or “target” means a nucleic acid sequence of interest in a sample that is being assayed.

“Targeted gene panel” or “gene panel” or “marker panel” means a select set of genes or gene regions that have known or suspected associations with the disease or phenotype under study. In some examples, the cartridges of the invention may be used to detect a disease state by assaying a marker panel.

For example, the cartridges may be used to assay a panel and the results can be used with a classifier, such as a cancer type classifier that predicts a disease state for a sample, such as a cancer or non-cancer prediction, a tissue of origin prediction, and/or an indeterminate prediction, e.g., using a classifier based on methylated or unmethylated fragments of DNA at certain genomic areas of interest. Examples of panels of markers and classification schemes suitable for use in the present invention are provided in Venn et al., International Patent Pub. No. WO2020163410, “Detecting cancer, cancer tissue of origin, and/or a cancer cell type,” filed on Feb. 5, 2020; Gross et al, International Patent Pub. No. WO2020163403, “Detecting cancer, cancer tissue of origin, and/or a cancer cell type,” filed on Feb. 4, 2020; Venn et al., International Patent Pub. No. WO2020154682, “Detecting cancer, cancer tissue of origin, and/or a cancer cell type,” filed on Jan. 24, 2020; Venn et al., International Patent Pub. No. WO2020069350, “Methylation markers and targeted methylation probe panel,” filed on Sep. 27, 2019; Darya et al., International Patent Pub. No. WO2019232435A1, “Convolutional neural network systems and methods for data classification,” filed on May 31, 2019; Venn et al., International Patent Pub. No. WO2019204360A1, “Systems and methods for determining tumor fraction in cell-free nucleic acid,” filed on Apr. 16, 2019; Gross et al, International Patent Pub. No. WO2019195268A2, “Methylation markers and targeted methylation probe panels,” filed on Apr. 2, 2019; Zhou et al., International Patent Pub. No. WO2017212428A1, “Cell-free DNA methylation patterns for disease and condition analysis,” filed on Jun. 7, 2017; Kang Zhang, U.S. Pat. No. 9,984,201B2, “Method and system for determining cancer status,” filed on Jan. 18, 2015; Kun Zhang, International Patent Pub. No. WO2015116837A1, “Methylation haplotyping for non-invasive diagnosis,” filed on Jan. 29, 2015; Kun Zhang, International Patent Pub. No. WO2018119216A1, “Deconvolution and detection of rare DNA in plasma,” filed on Dec. 21, 2017; Yuval Dor, International Patent Pub. No. WO2019012542A1, “Detecting tissue-specific DNA,” filed on Jun. 13, 2018; Yuval Dor, International Patent Pub. No. WO2019012543A1, “DNA targets as tissue-specific methylation markers,” filed on Jun. 13, 2018. All of the foregoing patents and applications are incorporated herein by reference in their entireties.

“Unique molecular identifiers” or “UMIs” or molecular barcodes” or “random barcodes” refer to indices added to libraries (e.g., sequencing libraries) before any PCR amplification steps, enabling the accurate bioinformatic identification of PCR duplicates. In the context of sequencing libraries, UMIs provides for error correction and increased accuracy during sequencing.

“Washing” with respect to washing a surface, such as a hydrophilic surface, means reducing the amount and/or concentration of one or more substances in contact with the surface or exposed to the surface from a droplet in contact with the surface. The reduction in the amount and/or concentration of the substance may be partial, substantially complete, or even complete. The substance may be any of a wide variety of substances; examples include target substances
for further analysis, and unwanted substances, such as components of a sample, contaminants, and/or excess reagent or buffer.

The terms “top,” “bottom,” “over,” “under,” and “on” are used throughout the description with reference to the relative positions of components of the droplet actuator, such as relative positions of top and bottom substrates of the droplet actuator. It will be appreciated that in many cases the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a dynamic film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### DETAILED DESCRIPTION OF THE INVENTION

In some embodiments, the presently disclosed subject matter provides a DMF system, device, and methods of integrating low-voltage sensing devices in a high-voltage DMF environment. For example, the presently disclosed DMF system, device, and methods may provide mechanisms to ensure the safe operation of low-voltage (e.g., <10V) sensing devices within the high-voltage (e.g., 10s to 100s of volts) environment of DMF.

In some embodiments, the presently disclosed DMF system, device, and methods may provide low-voltage (e.g., ≤10V) sensing devices that may include mechanisms for isolating the low-voltage sensing devices from the high voltages (e.g., 10s to 100s of volts) that may be present in the DMF environment.

In some embodiments, the presently disclosed DMF system, device, and methods may provide low-voltage (e.g., ≤10V) sensing devices that may include protection mechanisms for protecting against damage due to the low-voltage sensing devices coupling capacitively to the high voltages (e.g., 10s to 100s of volts) that may be present in the DMF environment.

In some embodiments, the presently disclosed DMF system, device, and methods may provide low-voltage (e.g., ≤10V) sensing devices, such as any low-voltage transistor-based sensors; such as metal-oxide-semiconductor field-effect transistor (MOSFET) devices; such as ion-sensing FET (ISFET) devices, FinFET devices, or photo-sensing devices.

In some embodiments, the presently disclosed DMF system, device, and methods may provide isolation or protection mechanisms, such as cutoff transistors connected to the source, drain, and well, respectively, of any MOSFET sensing device, which is the low-voltage sensing device.

In some embodiments, the presently disclosed DMF system, device, and methods may provide isolation or protection mechanisms that may be controlled (e.g., turned off and on) dynamically.

In some embodiments, the presently disclosed DMF system, device, and methods may provide isolation or protection mechanisms that may be used in an assay to (1) isolate or decouple the low-voltage (e.g., ≤10V) sensing devices during a DMF or droplet operations cycle of nearby droplet operations electrodes (e.g., electrowetting electrodes) and when the high DMF voltage (e.g., 10s to 100s of volts) is present, and (2) connect or activate the low-voltage (e.g., ≤10V) sensing devices during the detection or sensing cycle when the high DMF voltage (e.g., 10s to 100s of volts) is not present.

In some embodiments, the presently disclosed DMF system, device, and methods may provide a low-voltage (e.g., ≤10V) sensing device with protection mechanisms and wherein the protection mechanism may be the application of a voltage that is between ground and the DMF voltage to, for example, the source, drain, and well of any MOSFET sensing device during a DMF or droplet operations cycle of nearby droplet operations electrodes (e.g., electrowetting electrodes) and when the high DMF voltage (e.g., 10s to 100s of volts) is present and then the removal of this intermediate voltage during the detection or sensing cycle when the high DMF voltage (e.g., 10s to 100s of volts) is not present.

In some embodiments, the presently disclosed DMF system, device, and methods may provide a low-voltage (e.g., ≤10V) sensing device with protection mechanisms in each of the nanowells of a nanowell array of a DMF or droplet operations device.

In some embodiments, the presently disclosed DMF system, device, and methods may provide low-voltage sensing devices integrated safely into a high-voltage DMF environment and implemented on a DMF flip-chip cartridge that may further include flip-chip technology.

### Microfluidics System and DMF Technology

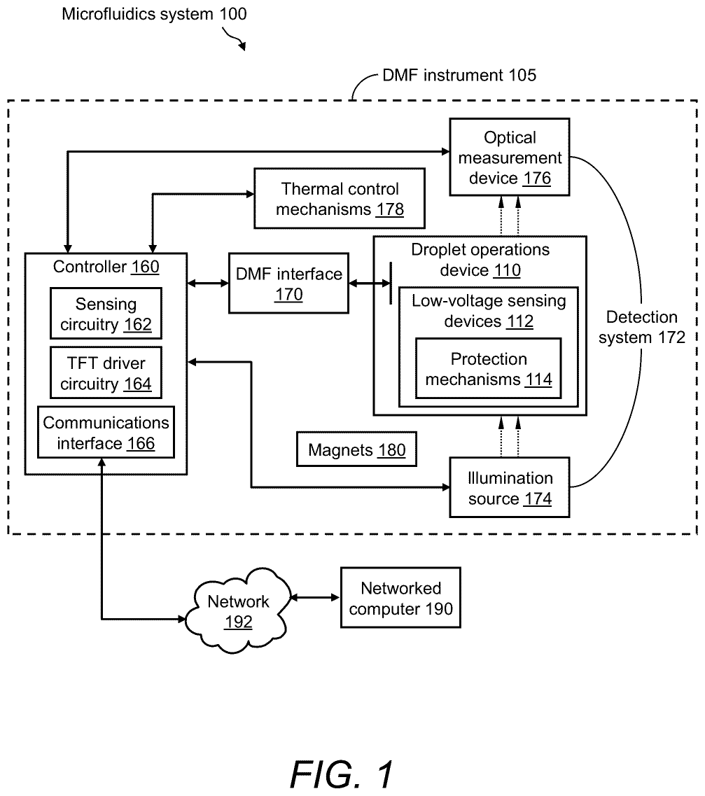

Referring now to FIG. 1 is a block diagram of an example of the presently disclosed microfluidics system 100 including low-voltage sensing devices integrated safely into a high-voltage DMF environment. Further, microfluidics system 100 includes mechanisms to ensure the safe operation of the low-voltage (e.g., <10V) sensing devices within the high-voltage (e.g., 10s to 100s of volts) environment of DMF.

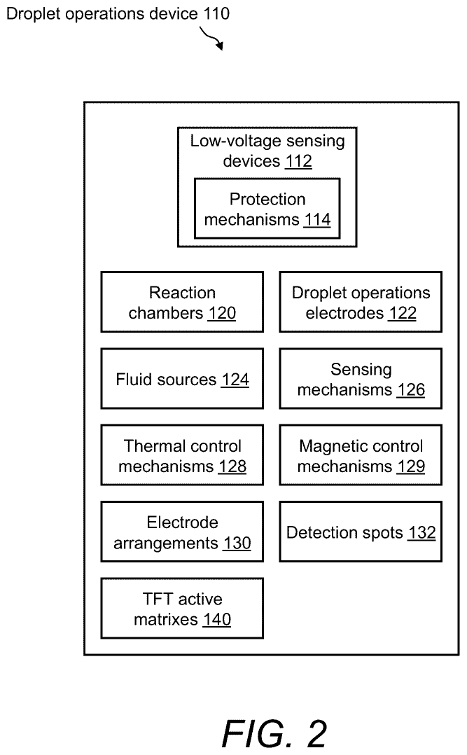

In various embodiments, the presently disclosed microfluidics system 100 may include a droplet operations device 110 that may support automated processes to manipulate, process and/or analyze biological materials. Droplet operations device 110 may be, for example, any DMF device or cartridge, droplet actuator, and the like that may be used to facilitate DMF capabilities generally for fluidic actuation. Droplet operations device 110 of microfluidics system 100 may be provided, for example, as a disposable and/or reusable DMF device or cartridge. More details of an example of droplet operations device 110 are shown and described hereinbelow with reference to FIG. 2.

DMF capabilities may generally include, but are not limited to, transporting, merging, mixing, splitting, dispensing, diluting, agitating, deforming (shaping), and other types of droplet operations. Applications of these DMF capabilities may include, for example, sample preparation and waste removal. Generally, microfluidics system 100 and droplet operations device 110 may be used to process biological materials.

However, particular to microfluidics system 100, in one example the DMF capabilities of droplet operations device 110 may be used transport droplets to and from detection spots that may include low-voltage (e.g., ≤10V) sensing devices 112, as described hereinbelow with reference to FIG. 2 through FIG. 13. Further, each of the low-voltage sensing devices 112 may include protection mechanisms 114 that may be used to substantially ensure the safe operation of the low-voltage sensing devices 112 within the high-voltage (e.g., 10s to 100s of volts) environment of DMF. For example, protection mechanisms 114 may be used to isolate the low-voltage sensing devices 112 during the high-voltage DMF cycles of nearby electrodes and then reconnect the low-voltage sensing devices 112 during optical detection or measurement cycles when the high DMF voltages (e.g., 10s to 100s of volts) are not present.

Microfluidics system 100 may further include a controller 160, a DMF interface 170, a detection system 172, and certain thermal control mechanisms 178. Controller 160 may be electrically coupled to the various hardware components of microfluidics system 100, such as to droplet operations device 110, detection system 172, thermal control mechanisms 178, and magnets 180. In particular, controller 160 may be electrically coupled to droplet operations device 110 via DMF interface 170, wherein DMF interface 170 may be, for example, a pluggable interface for connecting mechanically and electrically to droplet operations device 110.

Detection system 172 may be any detection mechanism that can be used to accurately determine the presence or absence of a defined analyte and/or target component in different materials and to sensitively quantify the amount of analyte and/or target components present in a sample. Detection system 172 may be, for example, an optical measurement system that includes an illumination source 174 and an optical measurement device 176. For example, detection system 172 may be a fluorimeter that provides both excitation and detection. In this example, illumination source 174 and optical measurement device 176 may be arranged with respect to droplet operations device 110.

The illumination source 174 may be, for example, a light source for the visible range (400-800 nm), such as, but not limited to, a white light-emitting diode (LED), a halogen bulb, an arc lamp, an incandescent lamp, lasers, and the like. Illumination source 174 is not limited to a white light source. Illumination source 174 may be any color light that is useful in microfluidics system 100. Optical measurement device 176 may be used to obtain light intensity readings. Optical measurement device 176 may be, for example, a charge coupled device, a photodetector, a spectrometer, a photodiode array, or any combinations thereof. Further, microfluidics system 100 is not limited to one detection system 172 only (e.g., one illumination source 174 and one optical measurement device 176 only). Microfluidics system 100 may include multiple detection systems 172 (e.g., multiple illumination sources 174 and/or multiple optical measurement devices 176) to support multiple detection spots.

Additionally, in some embodiments, droplet operations device 110 may include certain feedback mechanisms, such as impedance and/or capacitance sensing or imaging techniques, that may be used to determine or confirm the outcome of a droplet operation. Accordingly, controller 160 may further include certain sensing circuitry 162 for managing any feedback mechanism. In one example, a signal may be generated or detected by a capacitive sensor that can detect droplet position, velocity, and size. In another example, droplet operations device 110 may include a camera or other optical device to provide an optical measurement of the droplet position, velocity, and size. These droplet sensing mechanisms may be used to trigger controller 160 to re-route the droplets at appropriate positions. Further, this feedback may be used to create a closed-loop control system to optimize droplet actuation rate and verify droplet operations are completed successfully. Further, controller 160 may include certain thin-film transistor (TFT) driver circuitry 164 for controlling, for example, a TFT-based active matrix that may be provided in droplet operations device 110.

Most chemical and biological processes benefit from precise and stable temperature control for optimal efficiency and performance. Accordingly, thermal control mechanisms 178 may be any mechanisms for controlling the operating temperature of droplet operations device 110. For example, thermal control mechanisms 178 may be resistive heaters and/or thermoelectric (e.g., Peltier) devices arranged externally in thermal contact with droplet operations device 110.

Magnets 180 may be, for example, permanent magnets and/or electromagnets. In one example, magnets 180 may be external to droplet operations device 110. In another example, magnets 180 may be on-chip magnetics of droplet operations device 110. In the case of external electromagnets, controller 160 may be used to control the electromagnets 180.

Together, droplet operations device 110, controller 160, DMF interface 170, detection system 172 (e.g., illumination source 174 and optical measurement device 176), and thermal control mechanisms 178 may comprise a DMF instrument 105. Optionally, DMF instrument 105 may be connected to a network. For example, a communications interface 166 of controller 160 may be in communication with a networked computer 190 via a network 192. Networked computer 190 may be, for example, any centralized server or cloud-based server. Network 192 may be, for example, a local area network (LAN) or wide area network (WAN) for connecting to the internet.

Communications interface 166 may be any wired and/or wireless communication interface for connecting to a network (e.g., network 192) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, cellular networks, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+(Advanced Network Tools) technology, radio frequency (RF), Infrared Data Association (IrDA) compatible protocols, Local Area Networks (LAN), Wide Area Networks (WAN), Shared Wireless Access Protocol (SWAP), any other types of wireless networking protocols, and any combinations thereof.

Controller 160 may, for example, be a general-purpose computer, special purpose computer, personal computer, microprocessor, or other programmable data processing apparatus. Controller 160 may provide processing capabilities, such as storing, interpreting, and/or executing software instructions, as well as controlling the overall operations of microfluidics system 100. The software instructions may comprise machine readable code stored in non-transitory memory that is accessible by the controller 160 for the execution of the instructions. Controller 160 may be configured and programmed to control data and/or power aspects of microfluidics system 100. Further, data storage (not shown) may be built into or provided separate from controller 160.

Generally, controller 160 may be used to manage any functions of microfluidics system 100. For example, controller 160 may be used to manage the operations of sensing circuitry 162, TFT driver circuitry 164, communications interface 166, detection system 172 (e.g., illumination source 174 and optical measurement device 176), thermal control mechanisms 178, magnets 180, and any other instrumentation (not shown) in relation to droplet operations device 110. Further, with respect to droplet operations device 110, controller 160 may control droplet manipulation by activating/deactivating electrodes. Further, controller 160 may be used, for example, to authenticate droplet operations device 110, to verify that droplet operations device 110 is not expired, to confirm the cleanliness of droplet operations device 110 by running a certain protocol for that purpose, and so on.

In other embodiments of microfluidics system 100, the functions of controller 160, sensing circuitry 162, TFT driver circuitry 164, communications interface 166, detection system 172 (e.g., illumination source 174 and optical measurement device 176), thermal control mechanisms 178, magnets 180, and/or any other instrumentation may be integrated directly into droplet operations device 110 rather than provided separately from droplet operations device 110.

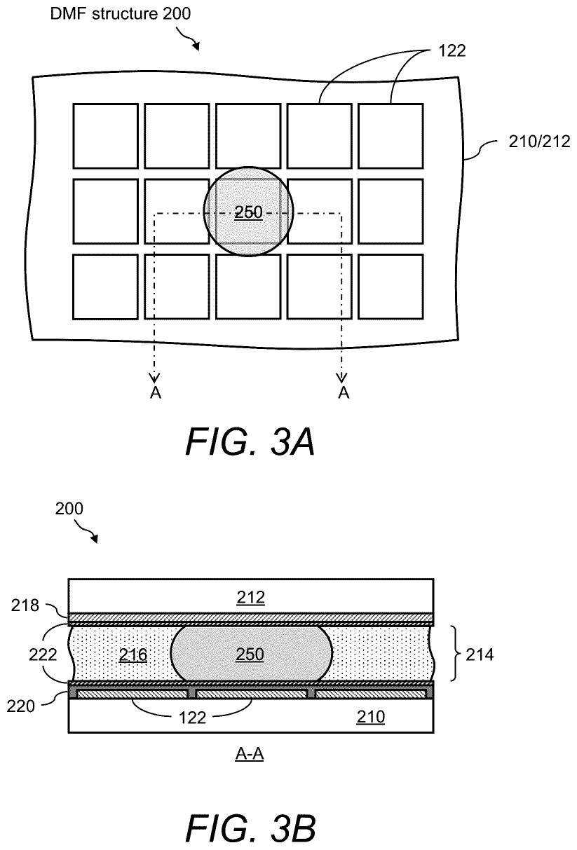

Referring now to FIG. 2 is a block diagram of an example of droplet operations device 110 of the presently disclosed microfluidics system 100 and wherein droplet operations device 110 may include low-voltage sensing devices 112 integrated safely into a high-voltage DMF environment. Generally, DMF devices consist of two substrates separated by a gap (see FIG. 3A and FIG. 3B) that forms a chamber in which the droplet operations are performed. In one example, a DMF device may include a silicon or printed circuit board (PCB) substrate and a glass or plastic substrate separated by a gap.

Again, a portion of droplet operations device 110 may be configured to transport droplets to and from detection spots 132 that may include low-voltage (e.g., ≤10V) sensing devices 112.

In some embodiments, low-voltage sensing devices 112 may be any low-voltage transistor-based sensors or detectors, such as MOSFET devices. Specific examples of low-voltage sensing devices 112 may include ISFET devices and/or FinFET devices. There is risk for damage to these low-voltage sensing devices 112 due to the low-voltage sensing devices 112 coupling capacitively to the high DMF voltages (e.g., 10s to 100s of volts) that may be present. To mitigate this risk, in one example, each of the low-voltage sensing devices 112 may include certain protection mechanisms 114 for isolating the low-voltage sensing devices 112 from capacitively coupling to the high DMF voltages. Accordingly, protection mechanisms 114 may be used to substantially ensure the safe operation of the low-voltage sensing devices 112 within the high-voltage (e.g., 10s to 100s of volts) environment of DMF. Protection mechanisms 114 may be, for example, cutoff transistors connected to the source, drain, and well, respectively, of each MOSFET device, which is any low-voltage sensing device 112.

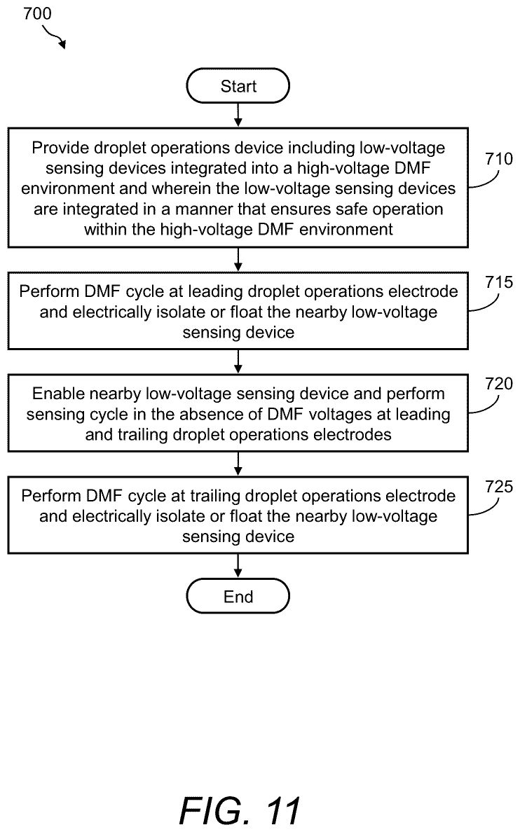

Further, protection mechanisms 114 may be controlled (e.g., turned off and on) dynamically using controller 160 and/or sensing circuitry 162. For example, protection mechanisms 114 may be used in an assay to (1) isolate or decouple the low-voltage sensing devices 112 during a DMF or droplet operations cycle of nearby droplet operations electrodes 122 (e.g., electrowetting electrodes) and when the high DMF voltage (e.g., 10s to 100s of volts) is present, and (2) connect or activate the low-voltage sensing devices 112 during the optical detection or sensing cycle when the high DMF voltages are not present. More details of an example method of using low-voltage sensing devices 112 with protection mechanisms 114 are provided hereinbelow with reference to FIG. 11.

Accordingly, droplet operations device 110 may include various other components for forming and/or supporting low-voltage sensing devices 112 with protection mechanisms 114 and/or any other functions and/or processes of droplet operations device 110. For example, droplet operations device 110 may further include any lines, paths, and/or arrays of droplet operations electrodes 122 for forming any number and configurations of reaction chambers 120, any number and configurations of fluid sources 124, any number and configurations of sensing mechanisms 126, any number and configurations of thermal control mechanisms 128, any number and configurations of magnetic control mechanisms 129 (e.g., for controlling on-chip magnetics (e.g., on-chip magnets 180) of droplet operations device 110), any number and configurations of electrode arrangements 130, any number and configurations of detection spots 132, and the like.

Accordingly, droplet operations device 110 may include one or more reaction (or assay) chambers 120. The one or more reaction chambers 120 may be supplied by any arrangements (e.g., lines, paths, arrays) of droplet operations electrodes 122 (i.e., electrowetting electrodes). Further, any droplet operations gap of droplet operations device 110 (e.g., the one or more reaction chambers 120) may be filled with a filler fluid (see FIG. 3B). The filler fluid may be a non-conductive immiscible fluid, such as a gas (e.g., air) or a liquid (e.g., an oil). Example oils may include silicone oil, hexane, and perfluorinated liquids.

Further, the one or more reaction chambers 120 and arrangements of droplet operations electrodes 122 of droplet operations device 110 may be supplied by any arrangements of fluid sources 124. Fluid sources 124 may be any fluid sources integrated with or otherwise fluidly coupled to droplet operations device 110. Fluid sources 124 may include any number and/or arrangements of, for example, on-cartridge reservoirs, off-cartridge reservoirs, blister packs, fluid ports, and the like, and any combinations thereof. Fluid sources 124 may include any liquids, such as reagents, buffers, and the like, needed to support low-voltage sensing devices 112 with protection mechanisms 114 and/or any other processes of droplet operations device 110.

Further, droplet operations device 110 may include sensing mechanisms 126. Sensing mechanisms 126 may be any components and/or elements built into droplet operations device 110 to support any feedback mechanisms, such as impedance or capacitance sensing. For example, sensors may be embedded at each droplet operations electrode 122 location to measure impedance, which enables monitoring and closed-loop control of certain droplet operations. Examples of other types of sensors may include temperature sensors, optical sensors, electrochemical sensors, voltage sensors, and current sensors. Sensing mechanisms 126 may be driven and/or controlled by sensing circuitry 162 of controller 160.

Further, droplet operations device 110 may include thermal control mechanisms 128. Thermal control mechanisms 128 may be any components and/or elements built into droplet operations device 110 to support any type of thermal control mechanisms 178. For example, closed loop control may be provided by thermal sensors embedded within the heater/cooler and a calibration step may be used to correlate the temperature within the heater/cooler to the temperature within the droplet operations gap of droplet operations device 110. In another example, resistive heaters may be integrated within droplet operations device 110. Examples include resistive wires or meandering traces at particular locations on the DMF device and/or discrete packaged components, such as surface mount resistors attached directly to droplet operations device 110. In another example, Joule heating or radiation may be used to heat the liquid droplets. Thermal control mechanisms 128 may be driven and/or controlled by controller 160.

Further, detection spots 132 of droplet operations device 110 may be any droplet operations electrodes 122 designated for detection operations via detection system 172. For example, in optical detection, illumination source 174 and optical measurement device 176 of detection system 172 may be provided in relation to a certain detection spot 134 at which a droplet to be analyzed may be transported to. For example, a low-voltage sensing device 112 with protection mechanisms 114 may be provided at each detection spot 132. More details of examples of low-voltage sensing devices 112 with protection mechanisms 114 are described hereinbelow with reference to FIG. 3 through FIG. 13.

Further, droplet operations device 110 may include TFT active-matrix technology, such as one or more TFT active matrixes 140. For example, a TFT active matrix 140 may be provided in relation to an arrangement of droplet operations electrodes 122. Any TFT active matrix 140 of droplet operations device 110 may be driven and/or controlled by TFT driver circuitry 164 of controller 160. Generally, active-matrix DMF devices based on TFT can enable particularly flexible and high-throughput DMF devices to be realized. In TFT, individual transistors (i.e., CMOS) are fabricated underneath each electrode (i.e., pixel) enabling electronics, such as switches and sensors, to be embedded at each electrode location. The embedded switches enable row-column based addressing which significantly reduces the number of connections to the device and allows arbitrarily large arrays of electrodes to be independently operated with a fixed number of electrical inputs to the device. The embedded TFT circuitry also enables sensors (e.g., sensing mechanisms 126) to be embedded at each electrode location. Again, for example, for measuring impedance which enables monitoring and closed-loop control of certain droplet operations. An example of TFT active-matrix technology that may be suitable for forming a TFT active matrix 140 in droplet operations device 110 may be the TFT active-matrix technology described in U.S. Pat. No. 7,163,612, entitled “Method, apparatus and article for microfluidic control via electrowetting, for chemical, biochemical and biological assays and the like,” issued on Jan. 16, 2007; the entire disclosure of which is incorporated herein by reference.

Additionally, droplet operations device 110 may be based on other DMF formats that are not based on traditional electrode arrays. For example, (1) Optical: In optoelectrowetting (OEW), a highly resistive a-Si:H layer switches the voltage on a virtual electrode defined by the pattern of illumination; (2) Magnetic: Ferrofluidic droplets or magnetic-bead containing droplets are manipulated by translating a permanent magnet or by using an array of electromagnets to create a magnetic field gradient. In a related implementation, droplets are manipulated indirectly by using a magnetic field to deform a film which creates topographical variation causing droplets to be operated on by gravitational forces; (3) Thermocapillary: Surface-tension driven flow based on a gradient of temperature. Example implementation is a PCB with an array of surface-mount resistors attached to the backside; and (4) Surface-acoustic wave.

Further, in microfluidics system 100 that includes droplet operations device 110, various DMF materials may be utilized. For example, insulators may include polyimide, parylene, SU-8, Si3N4, SiO, SiOC, PDMS, Ta₂O₅, Al₂O₃, BST, ETFE, or HfO₂. For example, hydrophobic coatings may include Cytop, Teflon AF, Fluoropel, Aquapel, SiOC. For example, substrates may include printed circuit board/FR4, glass, silicon, plastic, and paper. For example, transparent conducting coatings may include ITO, PEDOT, and CNT. Further, manufacturing technologies for DMF systems may be as follows: (1) Single layer—The simplest embodiments of DMF consist of a single conductive layer in which all electrodes, wires and pads are formed. Can be manufactured using lithography, screen-printing, inkjet printing, etc. Most suitable for low-cost, simple devices with larger features (i.e., diagnostics); (2) PCB technology—Provides multiple layers of electrical interconnect (e.g., 2-layer, 4-layer, 6-layer, 8-layer, etc.) which enables more complex designs and smaller features. Board-level integration with electronic components; and (3) TFT-based active-matrix technology as described hereinabove.

Referring now to FIG. 3A and FIG. 3B is a plan view and a cross-sectional view, respectively, of an example of a DMF structure 200. In one example, the formation of droplet operations device 110 of microfluidics system 100 may be based generally on DMF structure 200. FIG. 3A shows that DMF structure 200 may include any arrangements (e.g., lines, paths, arrays) of droplet operations electrodes 122 (i.e., electrowetting electrodes). In some embodiments, the DMF cartridge comprises an insulator material between the droplet operations gap and the low-voltage sensing device. In some embodiments, the insulator material is sensitive to a pH change. In some embodiments, the insulator material is tantalum oxide (Ta₂O₅). In some embodiments, the insulator material is hafnium oxide (HfO₂). In some embodiments, the insulator material is hafnium-doped tantalum oxide.

FIG. 3B shows that DMF structure 200 may include a bottom substrate 210 and a top substrate 212 separated by a droplet operations gap 214. Droplet operations gap 214 may contain filler fluid 216, such as silicone oil. Bottom substrate 210 may be, for example, a silicon substrate or a PCB. Bottom substrate 210 may include an arrangement of droplet operations electrodes 122 (e.g., electrowetting electrodes). Droplet operations electrodes 122 may be formed, for example, of copper, gold, or aluminum. A dielectric layer 220 (e.g., parylene coating, silicon nitride) may be atop droplet operations electrodes 122. Top substrate 212 may be, for example, a glass or plastic substrate. Top substrate 212 may include a ground reference electrode 218. In one example, ground reference electrode 218 may be formed of indium tin oxide (ITO) and wherein ITO is substantially transparent to light. Further, a hydrophobic layer 222 may be provided on both the side of bottom substrate 210 and the side of top substrate 212 that is facing droplet operations gap 214. Examples of hydrophobic materials or coatings may include, but are not limited to, polytetrafluoroethylene (PTFE), Cytop, Teflon™ AF (amorphous fluoropolymer) resins, FluoroPel™ coatings, silane, and the like. Droplet operations may be conducted atop droplet operations electrodes 122 on a droplet operations surface. For example, droplet operations may be conducted atop droplet operations electrodes 122 with respect to a droplet 250 (droplet operations electrodes 122 and droplet 250 not drawn to scale).

### Safe Operation of Low-Voltage Sensing Devices in a High-Voltage DMF Environment

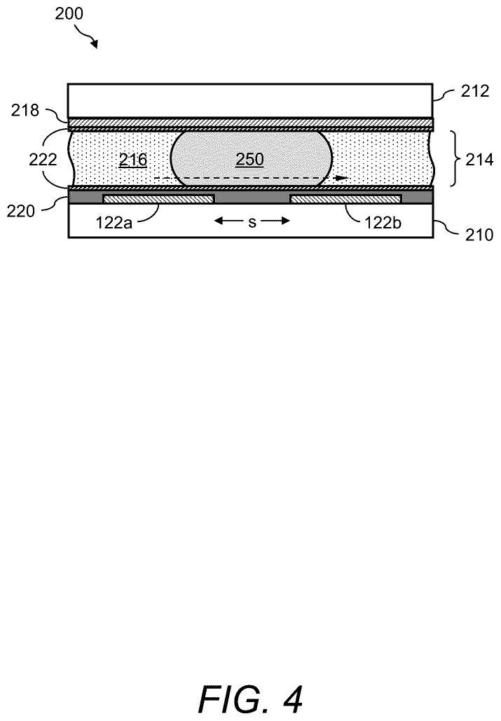

Referring now to FIG. 4 is a side view of another configuration of DMF structure 200 shown in FIG. 3B. In this example, there is a space s (not to scale) between droplet operations electrodes 122a and 122b. The space s is potentially a space in which a low-voltage sensing device 112 may be placed. Generally, one or more low-voltage sensing devices 112 may be placed in the space s between any two droplet operations electrodes 122. Additionally, in the example shown in FIG. 4, droplet 250 may be moving via droplet operations from droplet operations electrode 122a to droplet operations electrodes 122b. Accordingly, there may be a point in time in which droplet 250 may be contacting both droplet operations electrodes 122a and 122b and may be spanning the space s.

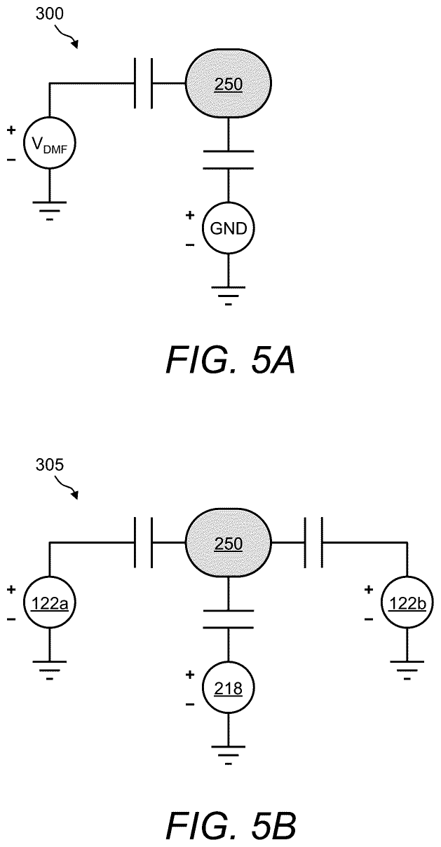

Further to the example, FIG. 5A and FIG. 5B is schematic diagrams of examples of equivalent circuits 300 and 305, respectively, showing the capacitive coupling with respect to droplet 250 in, for example, DMF structure 200 shown in FIG. 4.

Generally, droplet 250 has no direct connection to any voltage potential. Accordingly, droplet 250 may have a nominal starting potential of about 0V. Droplet 250 has capacitive coupling only. Equivalent circuit 300 of FIG. 5A shows generally that there may be a certain amount of capacitive coupling between droplet 250 and the DMF voltage (V_{DMF}) and wherein V_{DMF} may be, for example, from about 10s to about 100s of volts. Also, there may be a certain amount of capacitive coupling between droplet 250 and the ground reference (GND). More specifically and in the example of DMF structure 200, Equivalent circuit 305 of FIG. 5B shows that there may be a certain amount of capacitive coupling between droplet 250 and droplet operations electrode 122a, a certain amount of capacitive coupling between droplet 250 and droplet operations electrode 122b, and a certain amount of capacitive coupling between droplet 250 and ground reference electrode 218.

Referring still to equivalent circuit 305 of FIG. 5B, the ground reference capacitance is substantially constant because the droplet footprint area in contact with ground reference electrode 218 may be held substantially constant during droplet operations. By contrast, the capacitances at each droplet operations electrode 122 may change as droplet 250 moves, for example, from droplet operations electrode 122a to 122b. This is because the overlap area of droplet 250 with any droplet operations electrode 122 changes as droplet 250 moves. Accordingly, the droplet voltage potential may change with position. Accordingly, there may be a time component to the changing capacitances at each droplet operations electrode 122.

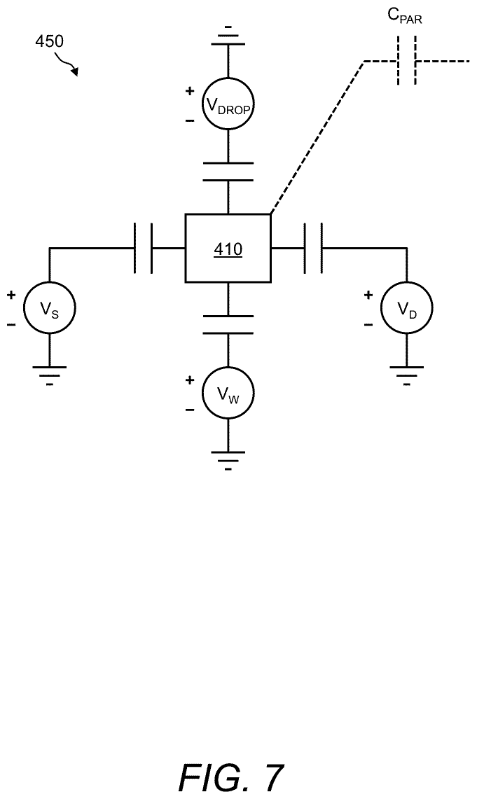

Also keep in mind that each of the droplet operations electrodes 122 may be switching between ground (0V, when V_{DMF} is off) and V_{DMF} (e.g., 10s to 100s of volts), and at different times. For example, at one certain time, droplet operations electrode 122a may be ON and droplet operations electrode 122b may be OFF. Here, the capacitive coupling of droplet 250 to V_{DMF} is highest near droplet operations electrode 122a and lowest near droplet operations electrode 122b. At a different time, droplet operations electrode 122a may be OFF and droplet operations electrode 122b may be ON. Here, the capacitive coupling of droplet 250 to V_{DMF} is lowest near droplet operations electrode 122a and highest near droplet operations electrode 122b. In both cases the capacitive coupling varies across the span of droplet 250. Further, any other conductors (not shown) near droplet 250 may provide other parasitic capacitances (see FIG. 7) and can couple capacitively to any other conductors, which can affect droplet potential.

Accordingly, the variables with respect to the capacitive coupling of a droplet in a DMF environment may include (1) whether a certain droplet operations electrode is ON or OFF, (2) the position of the droplet with respect to any one or more droplet operations electrodes, and (3) the position of the droplet with respect to any other conductors (i.e., resulting in parasitic capacitances).

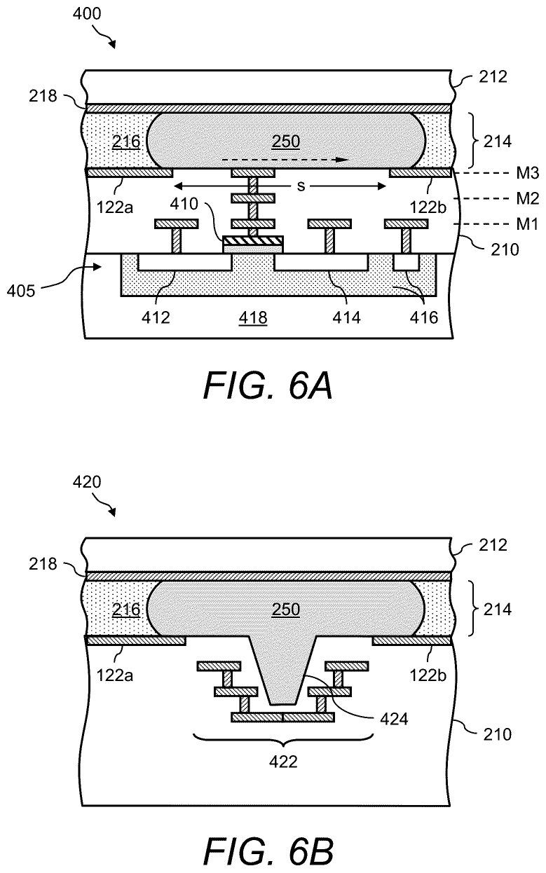

Referring now to FIG. 6A and FIG. 6B is side views of examples of DMF structures including a low-voltage sensing device alone without protection mechanisms. For example, FIG. 6A shows (not to scale) an example of a DMF structure 400 including a low-voltage sensing device 112 alone without protection mechanisms 114. In this example, DMF structure 400 is substantially the same as DMF structure 200 shown in FIG. 4 except for the additional inclusion of a low-voltage (LV) sensor 405. LV sensor 405 is an example of a low-voltage sensing device 112 shown in FIG. 1 and FIG. 2.

In one example, LV sensor 405 may be an ISFET formed using standard CMOS processes. In the example of an ISFET, LV sensor 405 may include a gate 410, a source 412, a drain 414, and a well 416 all formed with respect to a sensor substrate 418. Further, in this example, gate 410 of LV sensor 405 may be positioned in the space s between two droplet operations electrodes 122 (e.g., 122a and 122b). Accordingly, in this example, a 3-level metal process may be used including, for example, metal layers M1, M2, M3. A metal connection for each of source 412, drain 414, and well 416 is provided at metal layer M1. Then, for gate 410, a stack of metal connections (and vias) is provided at metal layer M1, then M2, and then M3. In this way, gate 410 is electrically connected upward to metal layer M3, which is the same level as droplet operations electrodes 122 and such that gate 410 may be in close proximity to droplet 250.

Generally, an ISFET is a field-effect transistor used for measuring ion concentrations in solution. The gate is an ion-sensitive membrane. When the ion concentration (such as H+, see pH scale) changes, the current through the transistor will change accordingly. In DMF, for example, the liquid droplet may be used as the gate electrode. A voltage potential develops between the substrate (e.g., sensor substrate 418) and the gate oxide surfaces due to an ion sheath. Accordingly, the general operation of LV sensor 405 is such that as a droplet (e.g., droplet 250) sits atop gate 410 of LV sensor 405 for some period of time, and as the pH in the droplet changes over time, there may be a reaction with the surface of the insulator layer of gate 410. This reaction changes the voltage potential on gate 410, which is measurable. For example, the gate potential controls the flow of current between source 412 and drain 414 that may be monitored via controller 160 and/or sensing circuitry 162 shown in FIG. 1.

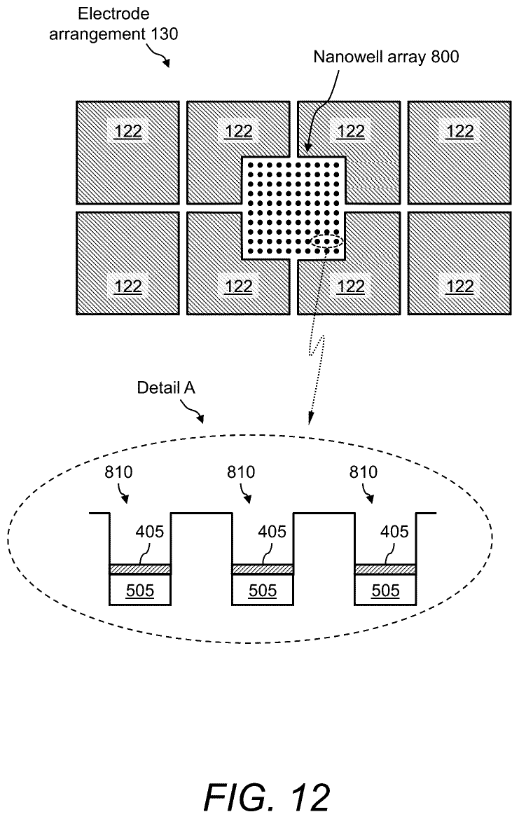

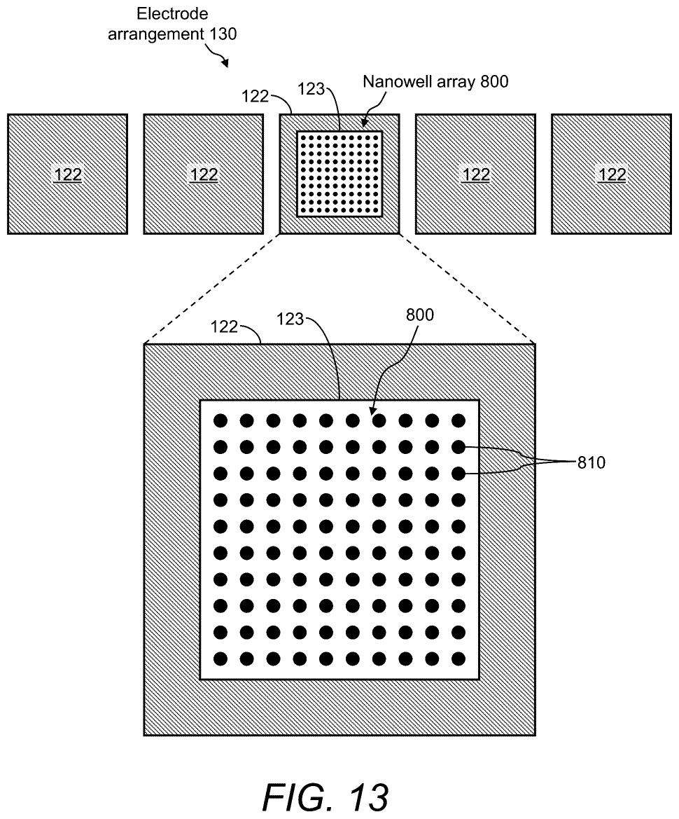

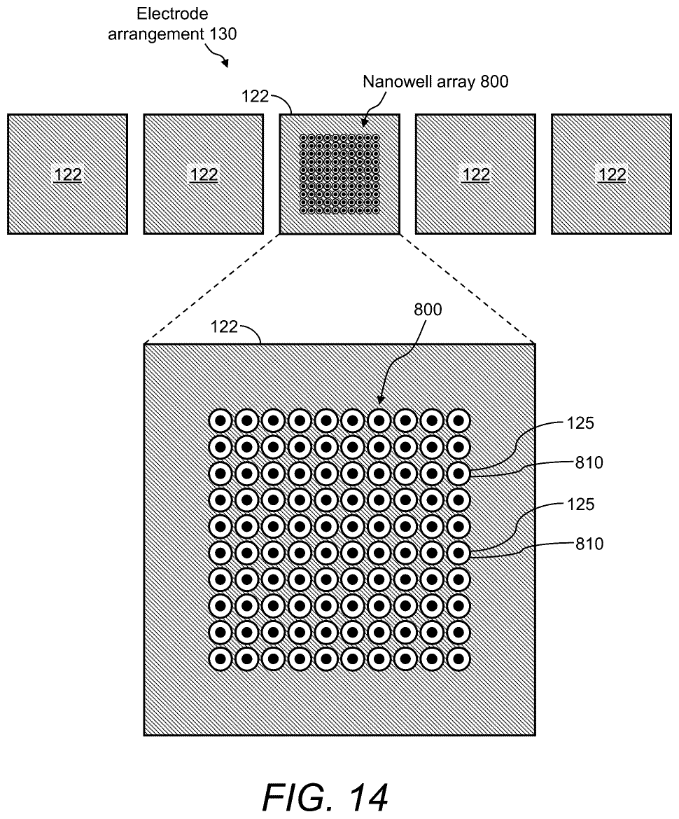

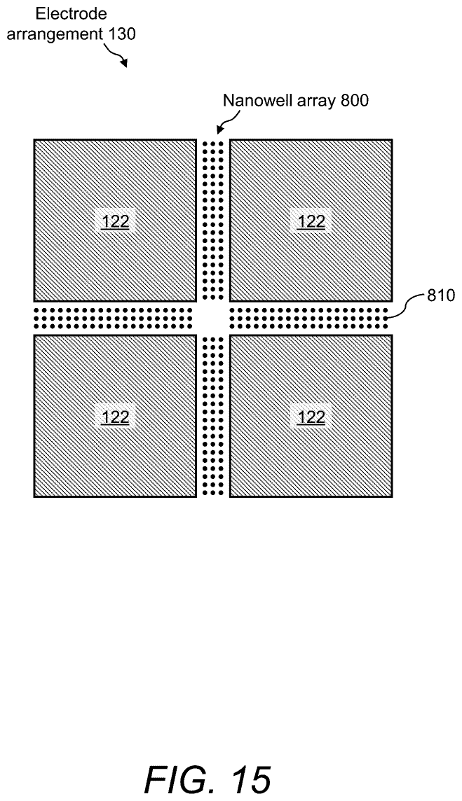

In another embodiment, the top-level metal (M3) of gate 410 of LV sensor 405 may be in direct contact with droplet 250 (i.e., absent any insulating layer) for direct exposure. In yet another embodiment, instead of a 3-metal stack at gate 410 of LV sensor 405, a connection is provided at metal layer M1 only. Then, a well (e.g., microwell or nanowell) may be etched downward to expose the M1 connection. Further, this vertical well may provide benefit for holding a micro- or nano-droplet during sensing. More details of an example of an array of nanowells including low-voltage sensing device 112 with protection mechanisms 114 are shown and described hereinbelow with reference to FIG. 12, FIG. 13, FIG. 14, and FIG. 15.

Next, FIG. 6B shows (not to scale) another example of a DMF structure 420 including a low-voltage sensing device 112 alone without protection mechanisms 114. In this example, the low-voltage sensing device 112 may be a photosensor 422 arranged with respect to a well 424 in bottom substrate 210. LV photosensor 422 is another example of a low-voltage sensing device 112 shown in FIG. 1 and FIG. 2. In this example, well 424 is etched to allow the liquid and biomaterial of droplet 250 to come close to photosensor 422, which is a low-voltage device with minimal capability of withstanding high voltages impinged on it. Capacitive coupling from droplet 250 to photosensor 422 and its metal connections can cause similar issues with high voltage on the low-voltage sensor.

Referring now to FIG. 7 is a schematic diagram 450 of an example of an equivalent circuit showing the capacitive coupling with respect to low-voltage sensing device 112 of DMF structure 400 shown in FIG. 6A. For example, there may be a certain amount of capacitive coupling between gate 410 of LV sensor 405 and the source voltage (V_{S}), there may be a certain amount of capacitive coupling between gate 410 of LV sensor 405 and the drain voltage (V_{D}), there may be a certain amount of capacitive coupling between gate 410 of LV sensor 405 and the well voltage (V_{w}), and there may be a certain amount of capacitive coupling between gate 410 of LV sensor 405 and the droplet voltage (V_{DROP}). Additionally, there may be parasitic capacitances (C_{PAR}) between gate 410 of LV sensor 405 and any other nearby conductors.

All of this capacitive coupling, especially the capacitive coupling to the droplet that may be capacitively coupled to the high DMF voltages, poses a risk to damaging any low-voltage sensing device 112 (e.g., LV sensor 405) of droplet operations device 110. The risk being any voltage exceeding the gate oxide breakdown voltage (BVOX) of, for example, the ISFET, which is an example of LV sensor 405. For example, the gate voltage (V_{G}) may be a function of the four voltage potentials shown in FIG. 7, depending on the relative capacitance values, and any additional possible parasitic capacitances (C_{PAR}).

The gate oxide breakdown only occurs with relative voltages exceeding the BVOX, as follows:
   |V_{G}−V_{S}|>BVOX, or |V_{G}−V_{D}|>BVOX, or |V_{G}−V_{W}|>BVOX

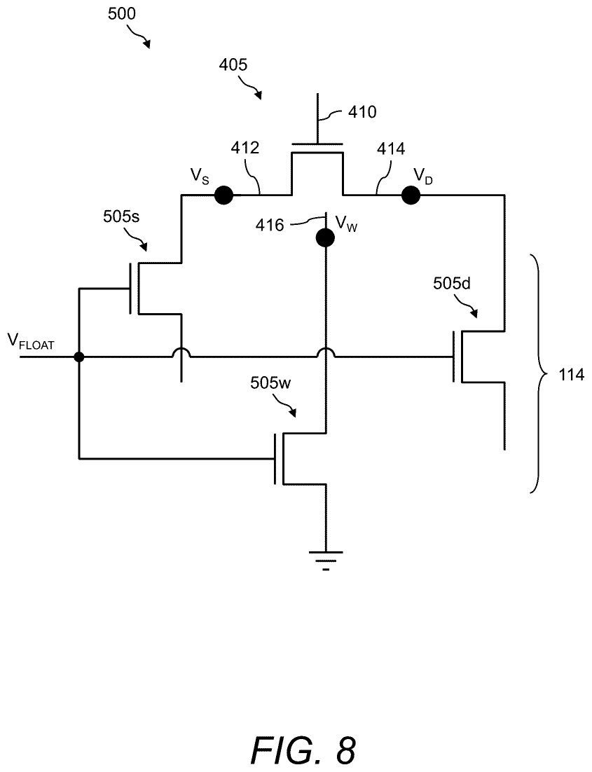

Accordingly, the presently disclosed invention may provide protection mechanisms 114 for preventing the occurrence of gate oxide breakdown conditions in low-voltage sensing devices 112 and thereby ensuring the safe operation of low-voltage sensing devices 112 in the high-voltage environment of DMF. For example, FIG. 8 shows a schematic diagram 500 of an example of LV sensor 405, which is an example of low-voltage sensing devices 112, and including an example of protection mechanisms 114 for ensuring the safe operation of LV sensor 405 in the high-voltage DMF environment.

In one example, protection mechanisms 114 provides a way to float the source, drain, and well of LV sensor 405 whenever a DMF voltage is present nearby and then reconnect the source, drain, and well of LV sensor 405 once the nearby DMF voltage is turned off. For example, cutoff transistors 505 may be used to float the source 412, drain 414, and well 416 of LV sensor 405. That is, a cutoff transistor 505s may be used to float the source 412 of LV sensor 405. A cutoff transistor 505d may be used to float the drain 414 of LV sensor 405. A cutoff transistor 505w may be used to float the well 416 of LV sensor 405. That is, under the control of controller 160 and/or sensing circuitry 162, a control line or voltage V_{FLOAT} may be used to turn cutoff transistors 505 on and off. For example, when control line or voltage V_{FLOAT} is active, cutoff transistors 505 are turned off, which floats LV sensor 405.

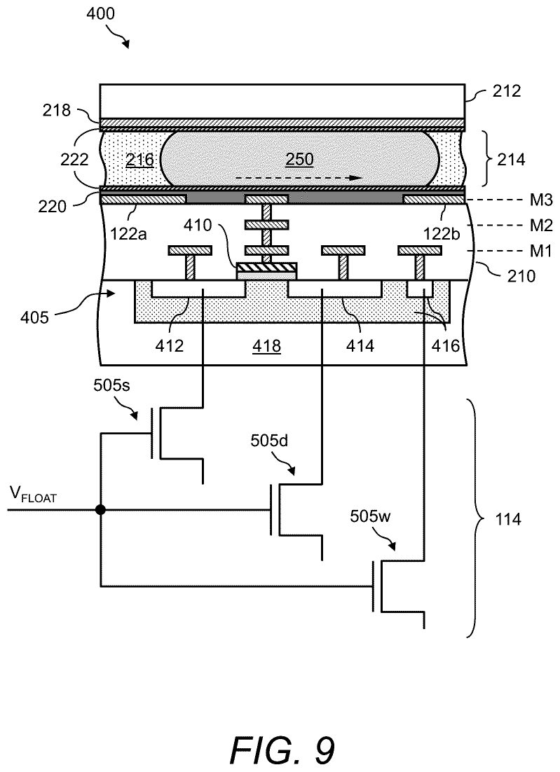

When cutoff transistors 505 are turned off, then LV sensor 405 may be considered in the “float” or “protected” condition within the high-voltage DMF environment. That is, in the “float” or “protected” condition, source 412, drain 414, and well 416 are allowed to float with the gate 410 of LV sensor 405. Another benefit of the “float” or “protected” condition is that the values of V_{GS}, V_{GD}. and V_{GW} are all smaller and thereby reducing the gate stress. The arrangement of cutoff transistors 505s, 505d, and 505w is one example of protection mechanisms 114. More particularly, LV sensor 405 with cutoff transistors 505s, 505d, and 505w is one example of a low-voltage sensing device 112 with protection mechanisms 114, respectively. Further, FIG. 9 shows pictorially an example of LV sensor 405 along with cutoff transistors 505s, 505d, and 505w shown in FIG. 8.

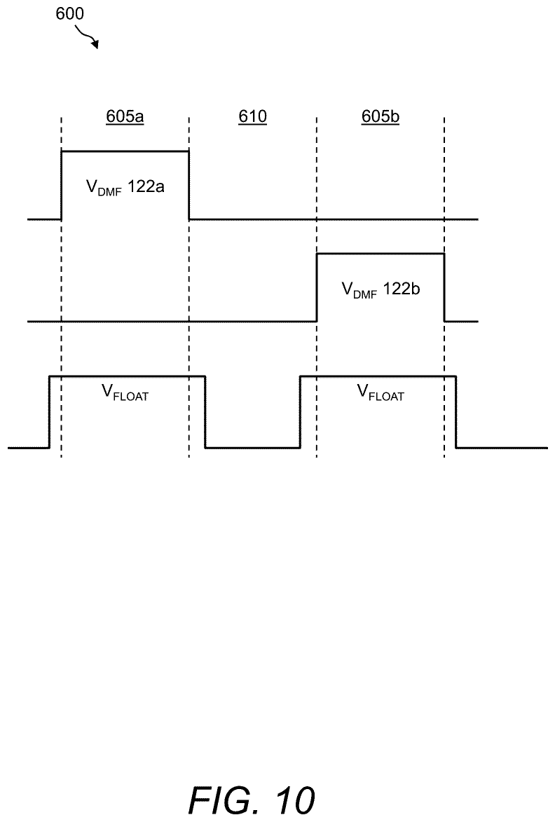

Referring now to FIG. 10 is an example of a timing diagram 600 of the operation of a low-voltage sensing device 112 (e.g., LV sensor 405) including protection mechanisms 114 (e.g., cutoff transistors 505) for ensuring the safe operation of low-voltage sensing device 112 in the high-voltage environment of DMF. For example, timing diagram 600 shows the control of a LV sensor 405 arranged between or near two droplet operations electrodes 122 (e.g., 122a, 122b) and wherein the control is via the control line or voltage V_{FLOAT} of cutoff transistors 505.

First, in a DMF cycle 605a, the V_{DMF} at droplet operations electrode 122a (V_{DMF} 122a) is active or turned ON; the V_{DMF} at droplet operations electrode 122b (V_{DMF} 122b) is inactive or turned OFF; and the control line or voltage V_{FLOAT} of cutoff transistors 505 is turned ON so that LV sensor 405 is in the “float” or “protected” condition while the nearby V_{DMF} 122a is turned ON. In one example, the control line or voltage V_{FLOAT} of cutoff transistors 505 is turned ON slightly before the V_{DMF} at droplet operations electrode 122a (V_{DMF} 122a) is active or turned ON.

Next, in a sensing cycle 610, the V_{DMF} 122a is inactive or turned OFF; the V_{DMF} 122b is inactive or turned OFF; and the control line or voltage V_{FLOAT} of cutoff transistors 505 is turned OFF so that LV sensor 405 is connected and able to perform sensing operations in the absence of V_{DMF} 122a and V_{DMF} 122b. In one example, the control line or voltage V_{FLOAT} of cutoff transistors 505 is turned OFF slightly after the V_{DMF} 122a is inactive or turned OFF.

Next, in a DMF cycle 605b, the V_{DMF} at droplet operations electrode 122a (V_{DMF} 122a) is inactive or turned OFF; the V_{DMF} at droplet operations electrode 122b (V_{DMF} 122b) is active or turned ON; and the control line or voltage V_{FLOAT} of cutoff transistors 505 is turned ON so that LV sensor 405 is in the “float” or “protected” condition while the nearby V_{DMF} 122b is turned ON. In one example, the control line or voltage V_{FLOAT} of cutoff transistors 505 is turned ON slightly before the V_{DMF} at droplet operations electrode 122b (V_{DMF} 122b) is active or turned ON.

To summarize, timing diagram 600 shows that the LV sensor 405 potentials may be floated (i.e., turned off via cutoff transistors 505) while the droplet 250 is moving around via the high DMF voltages. Then, once the high DMF voltages are turned OFF, cutoff transistors 505 may be turned ON to reconnect LV sensor 405. Because the source 412, drain 414, and well 416 connections of LV sensor 405 are floated, they will capacitively couple to gate 410 and V_{GS}, V_{GD}, and V_{GW} are smaller than they otherwise could have been in the absence of cutoff transistors 505. This reduces the gate stress and the likelihood of breaking down the gate.

Referring now to FIG. 11 is a flow diagram of an example of a method 700 of using the presently disclosed microfluidics system 100 including low-voltage sensing devices 112 integrated safely into a high-voltage DMF environment and according to a simplest configuration. Method 700 may include, but is not limited to, the following steps.

At a step 710, a droplet operations device is provided including one or more low-voltage sensing devices integrated into a high-voltage DMF environment and wherein the low-voltage sensing devices are integrated in a manner that ensures safe operation within the high-voltage DMF environment. For example and referring now to FIG. 1 through FIG. 10, droplet operations device 110 may be provided including one or more low-voltage (e.g., ≤10V) sensing devices 112 (e.g., LV sensors 405) and their corresponding protection mechanisms 114 (e.g., cutoff transistors 505) integrated into a high-voltage DMF environment and wherein the protection mechanisms 114 (e.g., cutoff transistors 505) may be used to ensure safe operation within the high-voltage (e.g., 10s to 100s of volts) DMF environment.

At a step 715, a DMF cycle is performed at the leading droplet operations electrode and at the same time electrically isolate or float the nearby low-voltage sensing device. For example, and referring now to FIG. 9 and FIG. 10, a DMF cycle 605a may be performed at the leading droplet operations electrode 122 (e.g., 122a) and at the same time the nearby low-voltage sensing device 112 (e.g., LV sensor 405) may be electrically isolated or floated using its corresponding protection mechanisms 114 (e.g., cutoff transistors 505). In one example, the DMF cycle is performed at the leading droplet operations electrode and, at a time slightly before, electrically isolate or float the nearby low-voltage sensing device. For example, referring to FIG. 9 and FIG. 10, the DMF cycle 605a may be performed at the leading droplet operations electrode 122 (e.g., 122a) and, at a time slightly before, the nearby low-voltage sensing device 112 (e.g., LV sensor 405) may be electrically isolated or floated using its corresponding protection mechanisms 114 (e.g., cutoff transistors 505).

At a step 720, the nearby low-voltage sensing device is enabled and then the sensing cycle is performed in the absence of the DMF voltages at the leading and trailing droplet operations electrodes. For example, and referring now to FIG. 9 and FIG. 10, the nearby low-voltage sensing device 112 (e.g., LV sensor 405) is enabled and then the sensing cycle 610 may be performed in the absence of the DMF voltages at the leading and trailing droplet operations electrodes 122 (e.g., 122a, 122b).

At a step 725, a DMF cycle is performed at the trailing droplet operations electrode and at the same time electrically isolate or float the nearby low-voltage sensing device. For example, and referring now to FIG. 9 and FIG. 10, a DMF cycle 605b may be performed at the trailing droplet operations electrode 122 (e.g., 122b) and at the same time the nearby low-voltage sensing device 112 (e.g., LV sensor 405) may be electrically isolated or floated using its corresponding protection mechanisms 114 (e.g., cutoff transistors 505). In one example, the DMF cycle is performed at the trailing droplet operations electrode and, at a time slightly before, electrically isolate or float the nearby low-voltage sensing device. For example, and referring now to FIG. 9 and FIG. 10, a DMF cycle 605b may be performed at the trailing droplet operations electrode 122 (e.g., 122b) and, at a time slightly before, the nearby low-voltage sensing device 112 (e.g., LV sensor 405) may be electrically isolated or floated using its corresponding protection mechanisms 114 (e.g., cutoff transistors 505).

Referring now to FIG. 12, FIG. 13, FIG. 14, and FIG. 15 is plan views of examples of electrode arrangements including a nanowell array (not to scale) and wherein each nanowell of the nanowell array may include a low-voltage sensing device 112 (e.g., LV sensor 405) with protection mechanisms 114 (e.g., cutoff transistors 505).

In one example, FIG. 12 shows an example of an electrode arrangement 130 including one nanowell array 800 (not to scale) including an array or any other arrangement of nanowells 810. Each nanowell 810 of nanowell array 800 may include a low-voltage sensing device 112 (e.g., LV sensor 405) with protection mechanisms 114 (e.g., cutoff transistors 505).

In this example, one nanowell array 800 may be provided among, for example, two lines of droplet operations electrodes 122. More specifically, one nanowell array 800 is sized and positioned substantially at the intersection of four droplet operations electrodes 122. In this example, the inner corner portion of each droplet operations electrode 122 may be cleared to accommodate nanowell array 800. Accordingly, in electrode arrangement 130, the four droplet operations electrodes 122 that are arranged with respect to nanowell array 800 may be used to transport (via droplet operations) an aqueous sample volume or droplet across and then away from nanowell array 800, while at the same time leaving behind a small-volume sample or droplet in each nanowell 810 of nanowell array 800.

Nanowells 810 of nanowell array 800 are hydrophilic nanowells. In one example, each hydrophilic nanowell 810 may hold a volume of liquid from, for example, about one femtoliter (e.g., about 1 μm×1 μm square or 1 μm diameter well) to about a few picoliters (e.g., about 10 μm×10 μm square or 10 μm diameter well). In one example, each hydrophilic nanowell 810 may hold a volume of liquid from, for example, about one attoliter to about a few femtoliters. Further, nanowells 810 of any nanowell array 800 may include any shape or footprint, such as, but not limited to, circular-shaped, square-shaped, octagon-shaped, hexagon-shaped, pentagon-shaped, and the like.

Generally, any nanowell array 800 may include, for example, from about tens to about thousands of nanowells 810. In one example, a nanowell array 800 may include from about 18,000 to about 100,000 nanowells 810. For example, nanowell array 800 may be a one-dimensional (1D) array, such as a 1×n array, or a two-dimensional (2D) array, such as any n×n array.

In the presently disclosed microfluidics system 100 including low-voltage sensing devices 112 (e.g., LV sensors 405) and protection mechanisms 114 (e.g., cutoff transistors 505), a Detail A of FIG. 12 shows that each of the nanowells 810 may include, for example, at least one LV sensor 405 with its corresponding cutoff transistors 505.

In another example, FIG. 13 shows an electrode arrangement 130 including a nanowell array 800 (not to scale) arranged within a single droplet operations electrode 122. In this example, nanowell array 800 may be arranged directly in the droplet transport pathway for ease of moving the aqueous sample volume or droplet across nanowell array 800. Again, each nanowell 810 of nanowell array 800 may include a low-voltage sensing device 112 (e.g., LV sensor 405) with protection mechanisms 114 (e.g., cutoff transistors 505).

In one example, droplet operations electrode 122 may be from about 300 μm to about 1200 μm square. In one example, each nanowell 810 of nanowell array 800 may be from about 1 μm to about 10 μm square or in diameter. Further, in electrode arrangement 130, a clearance region or window 123 is provided in one droplet operations electrode 122 to accommodate the placement of nanowell array 800. In this way, the metal of this droplet operations electrode 122 essentially frames the nanowell array 800 and can be used for transporting (via droplet operations) the aqueous sample volume or droplet across nanowell array 800. Again, in this example, each of the nanowells 810 may include, for example, at least one LV sensor 405 with its corresponding cutoff transistors 505.

In yet another example, FIG. 14 shows an electrode arrangement 130 including nanowell arrays 800 (not to scale) arranged within a single droplet operations electrode 122. Again, each nanowell 810 of nanowell array 800 may include a low-voltage sensing device 112 (e.g., LV sensor 405) with protection mechanisms 114 (e.g., cutoff transistors 505). In this example, electrode arrangement 130 may be substantially the same as electrode arrangement 130 shown in FIG. 13 except that instead of droplet operations electrode 122 including one large clearance region or window 123 to accommodate the placement of nanowell array 112, each nanowell 810 has its own individual clearance region 125.

In still another example, FIG. 15 shows an electrode arrangement 130 including nanowell arrays 800 (not to scale) arranged between droplet operations electrodes 122. Again, each nanowell 810 of nanowell array 800 may include a low-voltage sensing device 112 (e.g., LV sensor 405) with protection mechanisms 114 (e.g., cutoff transistors 505).

### Flip-Chip Technology

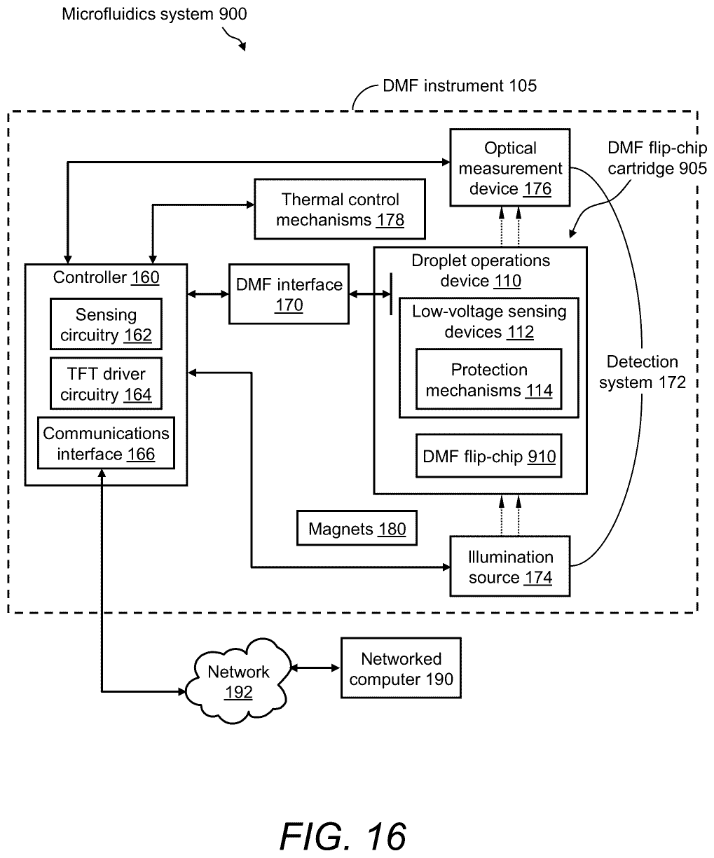

Referring now to FIG. 16 is a block diagram of an example of the presently disclosed microfluidics system 900 including low-voltage sensing devices integrated safely into a high-voltage DMF environment and implemented on a DMF flip-chip cartridge 905 that may further include flip-chip technology. Microfluidics system 900 may be substantially the same as microfluidics system 100 shown in FIG. 1 except that droplet operations device 110 further includes a DMF flip-chip 910. DMF flip-chip 910 installed on droplet operations device 110 forms DMF flip-chip cartridge 905.

More particularly, in microfluidics system 900, the portion of droplet operations device 110 that includes the low-voltage sensing device 112 (e.g., LV sensor 1005) with protection mechanisms 114 (e.g., cutoff transistors 505) may be substantially the same as the portion of droplet operations device 110 of microfluidics system 100 that includes the low-voltage sensing device 112 with protection mechanisms 114 and that is described hereinabove with reference to FIG. 1 through FIG. 15.

DMF flip-chip 910 may be any flip-chip technology including any insulating material having patterned conductors, such as a semiconductor chip, such as Si, SiC, or GaN, a glass chip, a multilayer laminate substrate, or Low-Temperature Co-fired Ceramic (LTCC) substrate.

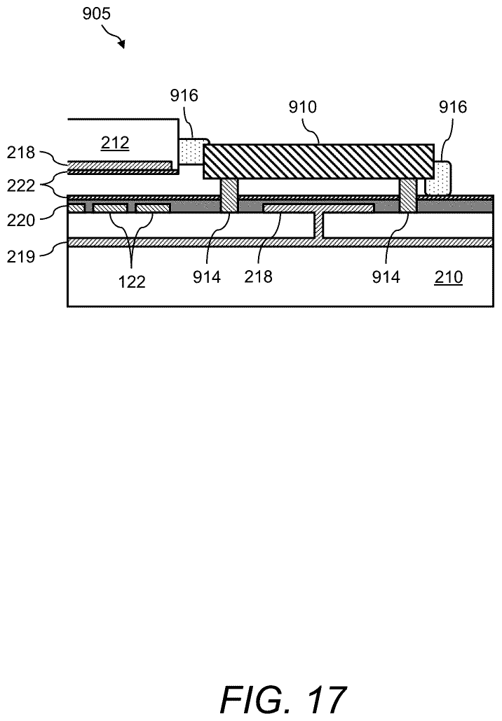

Referring now to FIG. 17 is a side view of a portion of an example of DMF flip-chip cartridge 905 of microfluidics system 900 shown in FIG. 16. In this example, the base structure of DMF flip-chip cartridge 905 may still be DMF structure 200 shown FIG. 9A and FIG. 9B but with the addition of DMF flip-chip 910 mounted atop bottom substrate 210 and alongside of top substrate 212.

In this example, bottom substrate 210 may be a PCB. The PCB may include, for example, a set of DMF control lines (i.e., electrical signals and/or electrowetting voltages) as well as a ground reference plane and/or lines. Accordingly, droplet operations may be performed on the PCB. The PCB may serve as the mechanical substrate for DMF flip-chip cartridge 905.

DMF flip-chip 910 may be mounted atop bottom substrate 210 using, for example, copper pillars 914. In addition to the mechanical fastening function of copper pillars 914, the copper pillars 914 may be used to provide a controlled standoff spacing between DMF flip-chip 910 and bottom substrate 210 for performing droplet operations (see FIG. 19). Copper pillars 914 may also be used for connection of electrical signals from the PCB to the chip 910. Further, a seal 916 may be provided around the perimeter of DMF flip-chip 910. In one example, seal 916 may be a silicone seal. One function of seal 916 is to prevent evaporation at the droplet operations surface. Another function of seal 916 is to contain filler fluid and/or other liquids inside the sealed region. Further, top substrate 212 may abut and/or overlap DMF flip-chip 910 to form a seal for the fluids in combination with seal 916.

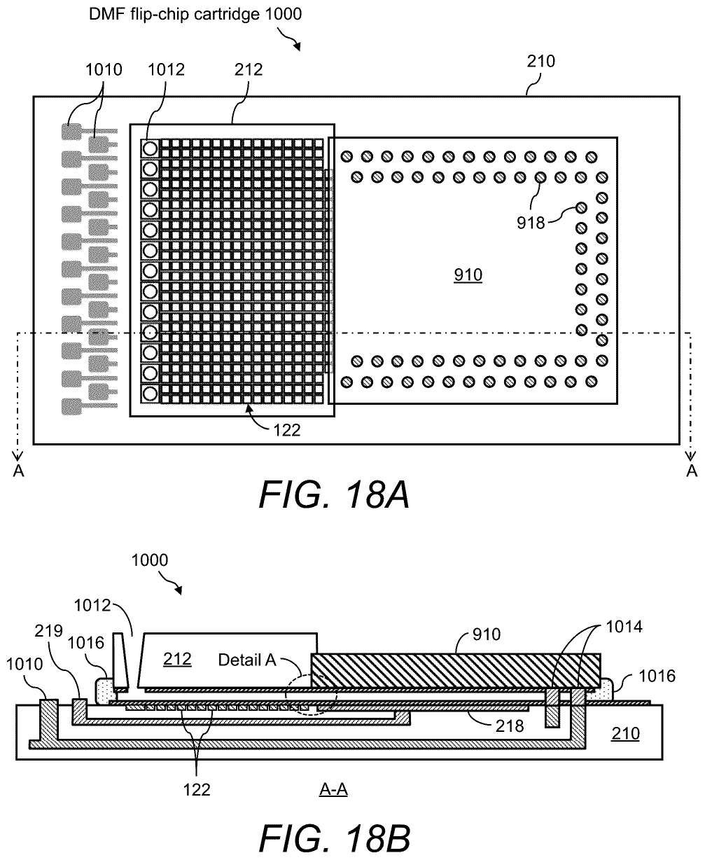

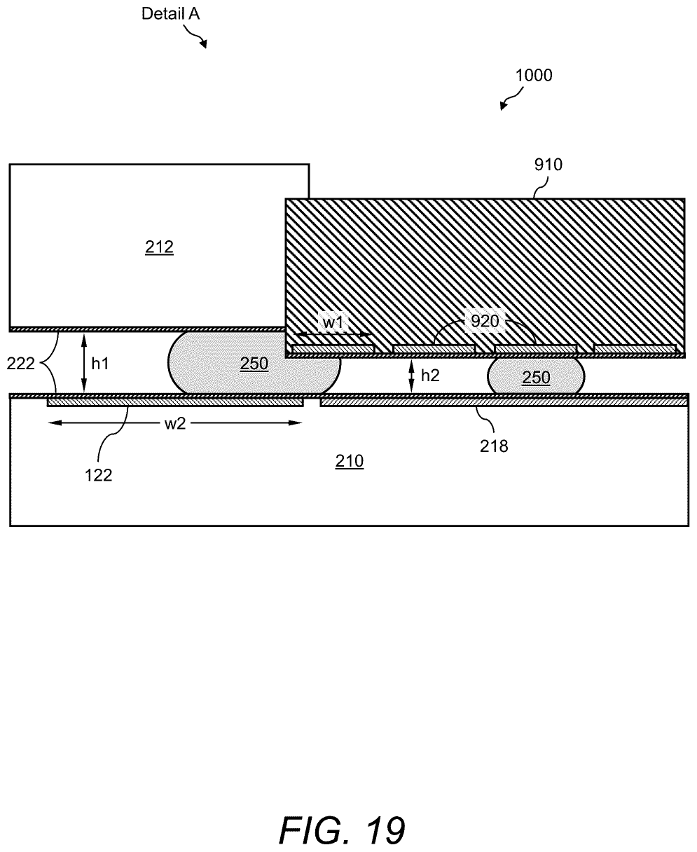

Referring now to FIG. 18A and FIG. 18B is a plan view and a cross-sectional view, respectively, showing more details of another example of a DMF flip-chip cartridge 1000 and wherein the DMF flip-chip cartridge 1000 includes one top substrate 212. FIG. 18B shows a cross-section taken along line AA of FIG. 18A. In this example, top substrate 212 is provided with respect to one portion of bottom substrate 210 and DMF flip-chip 910 is provided with respect to another portion of bottom substrate 210.

In this example, an array of droplet operations electrodes 122 may be provided at the portion of DMF flip-chip cartridge 1000 including bottom substrate 210 and top substrate 212. Further, bottom substrate 210 (the PCB) may include an arrangement of DMF control lines 1010 (i.e., electrical signals and/or electrowetting voltages). Further, top substrate 212 may include an arrangement of loading ports 1012 for loading liquid to be processed on DMF flip-chip cartridge 1000. Further, FIG. 18A shows that DMF flip-chip 910 has a plurality of input/output (I/O) pads 918. DMF flip-chip 910 may be mounted atop bottom substrate 210 using, for example, copper pillars 1014 that may provide a standoff spacer as well as electrical connection to I/O pads 918 of DMF flip-chip 910. Further, a seal 1016 may be provided around the perimeter of DMF flip-chip 910.

In this example, the portion of DMF flip-chip cartridge 1000 including bottom substrate 210 and top substrate 212 may be used to perform bulk DMF, as is well known. However, in DMF flip-chip cartridge 1000, using droplet operations, liquid may be transferred from the bulk DMF portion of bottom substrate 210 to DMF flip-chip 910. Additional droplet operations and/or sensing operations may be performed at DMF flip-chip 910.

Further, FIG. 18B shows that a ground reference electrode 218 may be provided on bottom substrate 210 and opposite DMF flip-chip 910. This ground reference electrode 218 may provide the ground reference for DMF operations of DMF flip-chip 910 and may be supplied by a ground reference line 219. By contrast, top substrate 212 also includes a ground reference electrode 218 (not shown) for performing the bulk DMF that is separate from the DMF operations of DMF flip-chip 910.

Generally, high electrowetting voltages (e.g., 10s to 100s of volts) may be present at the bulk DMF portion of DMF flip-chip cartridge 1000 (i.e., the portion of DMF flip-chip cartridge 1000 including bottom substrate 210 and top substrate 212). By contrast, low voltages (e.g., from about 40 volts to about 200 volts) may be used to perform the DMF operations at DMF flip-chip 910.

Referring now to FIG. 19 is a side view of a Detail A of FIG. 18A and FIG. 18B and showing more details of the transition portion of DMF flip-chip cartridge 1000 from the bulk DMF to the DMF operations of DMF flip-chip 910. In this example, droplet operations electrodes 920 may be provided on the surface of DMF flip-chip 910 that is opposite bottom substrate 210, and thus the need for ground reference electrode 218 on bottom substrate 210. Further, droplet operations electrodes 112 are atop bottom substrate 210 in the bulk DMF portion of DMF flip-chip cartridge 1000.

In one example, droplet operations electrodes 920 at DMF flip-chip 910 may be smaller than the droplet operations electrodes 112 atop bottom substrate 210. For example, droplet operations electrodes 920 may have a width w1 of from about 50 μm to about 1000 μm. Further, droplet operations electrodes 122 may have a width w2 of from about 400 μm to about 4000 μm.

A droplet (e.g., droplet 250) may move via droplet operations from droplet operations electrodes 112 atop bottom substrate 210 to droplet operations electrodes 920 of DMF flip-chip 910. In one example, there may be a certain gap height h1 between bottom substrate 210 and top substrate 212 and a smaller gap height h2 between bottom substrate 210 and DMF flip-chip 910. Gap height h1 may be, for example, from about 200 μm to about 1400 μm. Gap height h2 may be, for example, from about 10 μm to about 150 μm.

In this example, droplet 250 may be exposed to high voltage (e.g., 10s to 100s of volts) on droplet operations electrodes 122 of bottom substrate 210 as it transitions to DMF flip-chip 910. DMF flip-chip 910 need only to tolerate the high voltage at the first droplet operations electrode 920 at the edge of DMF flip-chip 910, and wherein the chip interior is not required to tolerate the high voltage. This is because, once droplet 250 moves off the droplet operations electrode 122 leading to DMF flip-chip 910 and onto the droplet operations electrodes 920 of DMF flip-chip 910, the voltage potential of the droplet drops to from about 100 volts to about 200 volts on droplet operations electrode 920.

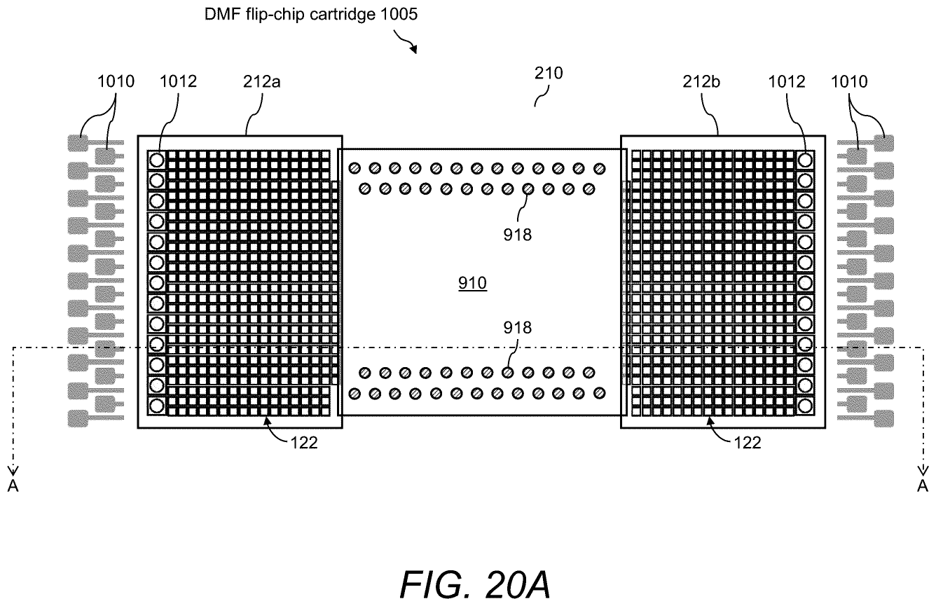

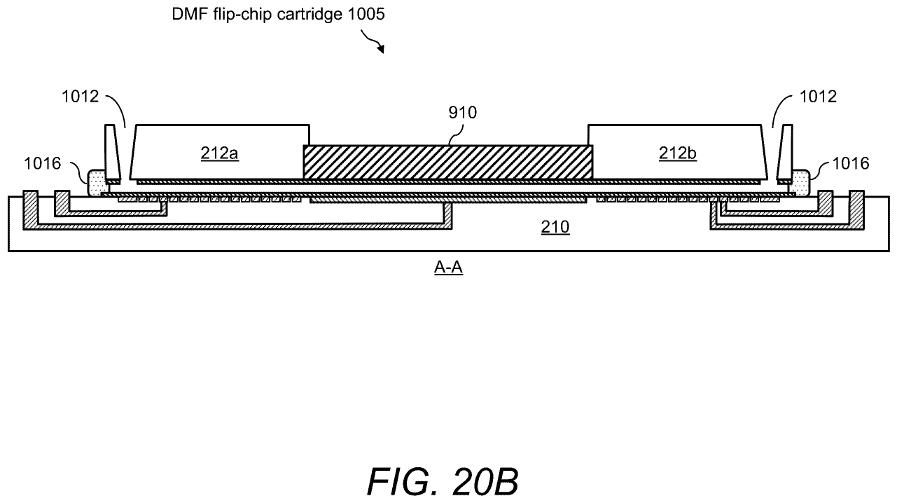

Referring now to FIG. 20A and FIG. 20B is a plan view and a cross-sectional view, respectively, showing more details of yet another example of a DMF flip-chip cartridge 1005 and wherein the DMF flip-chip cartridge includes two top substrates 212. In this example, DMF flip-chip cartridge 1005 may be substantially the same as DMF flip-chip cartridge 1000 shown in FIG. 18A and FIG. 18B except that DMF flip-chip 910 may be flanked on each side by a bulk DMF portion. For example, a top substrate 212a in relation to bottom substrate 210 may be provided on one side of DMF flip-chip 910 and wherein a droplet may transition from top substrate 212a to one side of DMF flip-chip 910. Further, a top substrate 212b in relation to bottom substrate 210 may be provided on the opposite side of DMF flip-chip 910 and wherein a droplet may transition from top substrate 212b to opposite side of DMF flip-chip 910.

DMF flip-chip cartridges, such as DMF flip-chip cartridges 1000 and 1005, are not limited to one or two bulk DMF portions feeding one or two sides, respectively, of one DMF flip-chip 910. In another embodiment, a DMF flip-chip cartridge may include three bulk DMF portions (e.g., including three top substrates 212) feeding three of the four sides of one DMF flip-chip 910. In yet another embodiment, a DMF flip-chip cartridge may include four bulk DMF portions (e.g., including four top substrates 212) feeding four of the four sides of one DMF flip-chip 910.

If a transparent chip with electrodes is used as top substrate(s) 212, then optical sensing of reactions due to DMF processing through top substrate(s) 212 is enabled. This provides the option of optically sensing outside of the cartridge.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the invention has been disclosed in connection with specific preferred aspects or embodiments, it should be understood that the invention as claimed should not be unduly limited to such specific aspects or embodiments.

The present invention may be implemented using hardware, software, or a combination thereof and may be implemented in one or more computer systems or other processing systems. In one aspect, the invention is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

We claim:

1. A method for operating a low-voltage transistor-based sensor in a high-voltage digital microfluidics system, the method comprising:
a) a high-voltage digital microfluidics system, wherein the high-voltage digital microfluidics system comprises a digital microfluidics cartridge, and wherein the digital microfluidics cartridge comprises:
i) a bottom substrate, wherein the bottom substrate comprises a plurality of droplet operation electrodes;
ii) a top substrate, wherein the top substrate is spaced apart from the bottom substrate forming a droplet operations gap therebetween; and
iii) a low-voltage transistor-based sensor, wherein the low-voltage transistor-based sensor comprises:
I) a metal oxide semiconductor field-effect transistor sensor, an ion-sensing field-effect transistor sensor, a fin field-effect transistor sensor or a photo-sensing device; and
II) a protection mechanism;
b) performing a droplet operation cycle, wherein the droplet operation cycle comprises applying a high-voltage to one or more of the droplet operation electrodes of the plurality of droplet operation electrodes for droplet manipulation;
c) activating, during the droplet operation cycle, the protection mechanism of the low-voltage transistor-based sensor, thereby isolating the low-voltage transistor-based sensor from the high-voltage applied to the one or more droplet operation electrodes; and
d) deactivating the protection mechanism and performing a sensing cycle operation, wherein the sensing cycle operation occurs at a low-voltage.

2. The method of claim 1, wherein the high-voltage applied to the one or more droplet operation electrodes during the droplet operation cycle is turned off during the sensing cycle operation.

3. The method of claim 1, wherein the low-voltage transistor-based sensor is an extended gate field-effect transistor, and wherein the extended gate field-effect transistor comprises:
a) a sensor and a gate; and
b) a source, a drain and a well, wherein each of the source, the drain and the well are capacitively coupled to the gate.

4. The method of claim 3, wherein the extended gate field-effect transistor further comprises a stacked metal layer comprising a bottom metal layer, a middle metal layer and a top metal layer, wherein the bottom metal layer is electrically connected to each of the source, the drain and the well, and wherein the bottom metal layer, the middle metal layer and the top metal layer are electrically connected to one another.

5. The method of claim 1, wherein the digital microfluidics cartridge comprises an insulator material between the droplet operations gap and the low-voltage transistor-based sensor and wherein the insulator material is pH sensitive.

6. The method of claim 5, wherein the insulator material is tantalum oxide, hafnium oxide or hafnium-doped tantalum oxide.

7. The method of claim 1, wherein the protection mechanism is configured to isolate the high-voltage applied to the one or more of the droplet operation electrodes of the plurality of droplet operation electrodes during the droplet operation cycle from the low-voltage transistor-based sensor, wherein the protection mechanism is further configured to isolate the low-voltage transistor-based sensor using a cutoff transistor operable to isolate the voltage applied to the low-voltage transistor-based sensor during the digital microfluidics electrode operation cycle during the droplet operation cycle.

8. The method of claim 1, wherein the protection mechanism comprises applying an intermediate voltage to the low-voltage transistor-based sensor, and wherein the intermediate voltage comprises a voltage between a ground voltage and the high-voltage applied to the one or more droplet operation electrodes of the plurality of operation electrodes during the droplet operation cycle.

9. The method of claim 1, wherein the bottom substrate further comprises one or more microwells.

10. The method of claim 8, wherein the intermediate voltage is between the ground voltage and the high-voltage applied during the droplet operation cycle and is calculated to be a safe voltage based on the high-voltage applied during the droplet operation cycle and based on a breakdown voltage of the sensor oxide.

11. A digital microfluidics cartridge, comprising:
a) a bottom substrate comprising a plurality of droplet operations electrodes;
b) a top substrate, wherein the top substrate is spaced apart from the bottom substrate forming a droplet operations gap therebetween; and
c) a low-voltage transistor-based sensor and a protection mechanism operable to isolate the low-voltage transistor-based sensor during a droplet operation cycle.

12. The digital microfluidics cartridge of claim 11, wherein the low-voltage transistor-based sensor comprises a metal oxide semiconductor field-effect transistor sensor, an ion-sensing field-effect transistor sensor, a fin field-effect transistor sensor, or a photo-sensing device.

13. The digital microfluidics cartridge of claim 11, wherein the low-voltage transistor-based sensor is an extended gate field-effect transistor, and wherein the extended gate field-effect transistor comprises:
a) a sensor and a gate; and
b) a source, a drain, and a well, wherein each of the source, the drain and the well are capacitively coupled to the gate.

14. The digital microfluidics cartridge of claim 13, wherein the extended gate field-effect transistor further comprises a stacked metal layer comprising a bottom metal layer, a middle metal layer and a top metal layer, wherein the bottom metal layer is electrically connected to each of the source, the drain and the well, and wherein the bottom metal layer, the middle metal layer and the top metal layer are electrically connected to one another.

15. The digital microfluidics cartridge of claim 14, wherein the protection mechanism comprises one or more cutoff transistors, and wherein the one or more cutoff transistors are operable to isolate one or more of the source, the drain and the well of the extended gate field-effect transistor.

16. The digital microfluidics cartridge of claim 15, wherein the protection mechanism comprises one or more cutoff transistors, wherein the one or more cutoff transistors are coupled to one or more of the source, the drain and the well and wherein the one or more cutoff transistors are operable to isolate the low-voltage transistor-based sensor during the digital microfluidics device electrode operation cycle.

17. The digital microfluidics cartridge of claim 13, wherein the digital microfluidics cartridge comprises a flip-chip cartridge that is mounted atop the bottom substrate and alongside of the top substrate, wherein the top substrate further comprises one or more loading ports operable for loading a liquid to be processed on the flip-chip cartridge.

18. The digital microfluidics cartridge of claim 11, wherein the bottom substrate further comprises one or more microwells.

19. The digital microfluidics cartridge of claim 11, further comprising an insulator material between the droplet operations gap and the low-voltage transistor-based sensor.

20. The digital microfluidics cartridge of claim 19, wherein the insulator material is sensitive to pH changes.
